(19) United States
(12) Patent Application Publication
(10) Pub. No.: US 2023/0410873 A1
(43) Pub. Date: Dec. 21, 2023

(54) Methods and Apparatus for Probabilistic Refresh in Volatile Memory Devices

(71) Applicant: Micron Technology, Inc., Boise, ID (US)

(72) Inventors: David Hulton, Boise, ID (US); Jeremy Chritz, Boise, ID (US); Jonathan D. Harms, Boise, ID (US)

(21) Appl. No.: 18/456,152

(22) Filed: Aug. 25, 2023

Related U.S. Application Data
(62) Division of application No. 17/013,402, filed on Sep. 4, 2020.

(51) Int. Cl. G11C 11/406; G06F 11/07; G06F 16/2458; G11C 11/4096

(52) U.S. Cl. CPC G11C 11/406; G06F 11/073; G06F 11/076; G06F 16/2465; G11C 11/4096; G06F 11/0787; G06F 2216/03; G06Q 20/0655

(57) ABSTRACT

Methods and apparatus for utilizing non-traditional (e.g., probabilistic or statistically-based) refresh schemes in non-volatile memory. In one embodiment, the memory is characterized in terms of its performance, such as based on BER (bit error rate) as a function of refresh rate based on statistical data for decay of capacitance within the cells of the device with time. In one variant, error-tolerant applications make use of the non-traditionally refreshed (or unrefreshed) memory with enhanced memory bandwidth, since refresh operations have been reduced or eliminated. In another variant, an extant refresh scheme is modified based on a specified minimum allowable performance level for the memory device, In yet another embodiment, error-intolerant applications operate the memory with a reduced or eliminated refresh, and cells or regions of the memory not adequately refreshed by presumed random read/write operations of the memory over time are actively refreshed.

### RELATED APPLICATIONS

The present application is a divisional application of U.S. patent application Ser. No. 17/013,402, filed Sep. 4, 2020, the entire disclosures of which applications are incorporated herein by reference.

The present application is related to U.S. patent application Ser. No. 16/505,472, filed Jul. 8, 2019 and entitled “Methods and Apparatus for Dynamically Adjusting Performance of Partitioned Memory,” the entire disclosures of which applications are incorporated herein by reference.

Copyright

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

The present disclosure relates generally to semi-conductor memory devices and more specifically in one exemplary aspect to the implementation of probabilistic refresh in volatile memory devices such as, for example, dynamic random-access memory (DRAM).

### BACKGROUND

Memory devices are widely used to store information in various electronic devices such as computers, wireless communication devices, cameras, digital displays, and the like. Information is stored by programing different states of a memory device. For example, binary devices have two states, often denoted by a logical “1” or a logical “0.” To access the stored information, the memory device may read (or sense) the stored state in the memory device. To store information, the memory device may write (or program) the state in the memory device. So-called volatile memory devices may require power to maintain this stored information, while non-volatile memory devices may persistently store information even after the memory device itself has, for example, been power cycled.

DRAM is a type of random access memory that stores data in a capacitor within an integrated circuit. Each bit of information may be stored as either the presence or absence of an electric charge on the capacitor located within the memory device. As time passes in a volatile memory array, the charges in these memory cells begin to dissipate; over a long enough interval (e.g., 60 milliseconds (ms)) the stored information is lost. In order to ensure that the DRAM contents remain valid for longer times, “refresh” circuitry periodically reads each cell and rewrites it, thereby restoring the charge on a given memory cell (e.g., a capacitor) to its original level.

Capacitive discharge is a physical property of each memory cell's capacitor, and due to manufacturing tolerances some memory cells may have longer discharge times than others. For practical purposes, a DRAM will progressively accumulate bit errors over time if the refresh interval is too long. Within the context of the general compute paradigm, reliability is measured as bit error rate (BER). Thus, higher reliability memory may be characterized by more frequent refreshes of memory (e.g., every 60 ms), while lower reliability memory may be characterized by less frequent or no refreshes of volatile memory.

Memory refresh is typically a background maintenance process that is required during the operation of the memory device. This refresh process is typically conducted automatically in the background by the memory circuitry, and is otherwise transparent to the user. However, during a refresh cycle, the memory device is not available for normal read and write operations. These periodic refresh cycles introduce, inter alia, additional processing overhead and power consumption, thereby diminishing memory device throughput and performance. Furthermore, refresh cycles are typically performed over large memory spaces, and can therefore consume comparatively large amounts of memory bandwidth.

In terms of memory accesses for such volatile devices, existing cache memory techniques allow very fast memory accesses to certain, frequently used or prescribed memory locations. However, some applications (including many emerging technologies) need to perform random/pseudo-random memory accesses that are not limited to particular memory locations. These memory applications are difficult to handle with existing cache techniques, at least in part because they are potentially distributed over a large memory space.

Hence, the confluence of the foregoing issues presents unique challenges, including how to efficiently perform such “distributed” memory accesses within a volatile device, while also mitigating the effects of having to perform refresh operations.

Accordingly, what is needed are improved apparatus and methods for memory access over e.g., a distributed search space. Specifically, in one particular aspect, apparatus and techniques are needed to allow for reduction of refresh requirements, including in such distributed search scenarios as well as others which the volatile memory device may encounter depending on its particular chosen application.

### SUMMARY

The present disclosure addresses the foregoing needs by providing, inter alia, methods and apparatus for provision of probabilistic refresh in volatile memory device is disclosed.

In a first aspect, a method of increasing the useful bandwidth of a memory device is disclosed. In one embodiment, the memory device is a volatile device, and the method includes selectively obviating at least portions of extant refresh functionality based at least on one or more probabilistic considerations or characterizations.

In another embodiment, the method includes: designing a volatile memory device to have no refresh capability; and operating the memory device without refresh based at least on one or more probabilistic considerations. In one variant, the one or more probabilistic considerations include a statistical function relating BER and rate of “refresh” by e.g., memory accesses.

In another aspect, a memory device is disclosed. In one embodiment, the memory device is a volatile device, and includes: at least one array of memory cells; refresh logic; and controller logic in operative communication with the refresh logic and configured to cause the memory device to implement one or more probabilistic refresh schemes.

In another embodiment, the memory device is a volatile device, and includes: at least one array of memory cells; and controller logic in operative communication with the memory device and configured to cause the memory device to implement one or more probabilistic “refresh” schemes via a plurality of memory accesses.

In one variant, the memory device is configured to overfetch data consistent with the controller's bandwidth so as to effect at least part of the probabilistic refresh scheme.

In another aspect, a method of operating a memory device is disclosed. In one embodiment, the method includes: identifying a prescribed minimum performance level; and operating the memory device according to a probabilistic scheme so as to achieve the minimum performance level.

In one variant, the method includes selectively parallelizing a plurality of memory accesses so as to comport with the probabilistic scheme (e.g., achieve refresh of a desired portion of the memory device within a prescribed time period).

In another variant, the method includes: identifying at least one cell within the memory device that has not been accessed within a prescribed time period associated with the probabilistic scheme, and actively refreshing that at least one cell using refresh circuitry of the memory device.

In another variant, the method includes: identifying at least one cell within the memory device that has not been accessed within a prescribed time period associated with the probabilistic scheme, and refreshing that at least one cell using one or more scheduled or unscheduled accesses.

In another aspect, a computing system is disclosed. In one embodiment, the system includes an application, an operating system (OS), a memory driver, and a memory device. In one variant, the memory device is probabilistically controlled by the memory driver and OS. In another variant, the application is located within an untrusted domain, while the OS and other components are located within the trusted domain.

In another aspect, a method of performing a uniform search of a memory device or array is disclosed. In one embodiment, the search is associated with a crypto- mining process, and the method includes use of non-validated or unreliable memory for performing a uniform memory search for a solution.

In another aspect, a method of performing a non-uniform search of a memory device or array is disclosed.

In a further aspect, a method for operating a volatile memory device is described. In one embodiment, the method includes: characterizing the volatile memory device in terms of statistical performance; identifying a prescribed minimum level of performance for the volatile memory device during operation; and operating the volatile memory device without utilization of refresh logic for at least a period of time based at least on the characterization and the prescribed minimum level of performance.

In one variant, the operating the volatile memory device includes operating while in a host device within which the volatile memory device has been permanently installed; and the characterizing the volatile memory device in terms of statistical performance includes characterizing BER (bit error rate) as a function of refresh rate.

In one implementation thereof, the operating the volatile memory device without utilization of refresh logic for at least a period of time includes operating the volatile memory device without utilization of refresh logic indefinitely; and the identifying a prescribed minimum level of performance for the volatile memory device during operation includes identifying a prescribed minimum level of performance for the volatile memory device which enables such indefinite operation without utilization of said refresh logic based at least on one or more processes occurring during operation of the volatile memory device. The one or more processes occurring during operation of the volatile memory device may comprise for example at least one of memory read or memory write operations initiated by a memory controller or operating system of a computerized device within which the volatile memory device is utilized (e.g., memory read or memory write operations initiated by a crypto-currency mining application executing on the computerized device), or at least one physical process occurring within the volatile memory device, the effects of the physical process being substantially randomized (e.g., row hammer or bit-flip due to solar radiation, or yet other physical processes).

In another variant, the characterizing the volatile memory device in terms of statistical performance includes generating a characterization applicable to a plurality of devices sharing a common feature, the volatile memory device being one of the plurality of devices. For instance, the common feature may include a common volatile memory device type, a common volatile memory device manufacturing process or lot, or yet other factor(s).

In another aspect, a computing device is disclosed. In one embodiment, the device includes: a processing apparatus; a first memory device in data communication with the processing apparatus, the first memory device having a first level of performance associated therewith; a second memory device in data communication with the processing apparatus, the second memory device having a second level of performance associated therewith which is lower than the first level; and non-transitory computer readable apparatus in data communication with the processing apparatus and comprising a storage medium having a plurality of computer-readable instructions.

In one variant, the plurality of computer-readable instructions, when executed by the processing apparatus, are configured to: execute an application requiring a plurality of accesses to the second memory device for at least a period of time; and thereafter, cause replacement of at least a portion of contents of the second memory device with a respective at least portion of contents of the first memory device.

In one implementation, the application includes an application with error tolerance at least to the second level of performance. In another implementation, the first and second memory devices comprise volatile memory; and the computing device is configured to operate at least the second memory device without refresh logic during at least the period of time. For example, the application may comprise an application which utilizes at least one of (i) a uniform random access strategy, or (ii) a sequentially uniform strategy, for searching the second memory device.

In another implementation, the first and second memory devices comprise volatile memory; and the computing device is configured to operate at least the second memory device at a reduced rate of refresh relative to a design rate of refresh during at least the period of time.

In a further aspect, a non-transitory computer readable apparatus comprising a storage medium having a plurality of computer-readable instructions is disclosed. In one embodiment, the plurality of computer-readable instructions are configured to, when executed by a processing apparatus: receive data identifying a prescribed minimum level of performance for use during operation of a volatile memory device; access a data structure comprising (i) first data identifying a plurality of performance values or ranges, and (ii) second data associated with a refresh rate for the respective ones of the plurality of performance values or ranges; based at least on the received data, select one of the second data; and cause operation of the volatile memory device with a refresh rate associated with the selected one of the second data.

In one variant, the first data and second data of the data structure are based at least in part on a probabilistic characterization of the memory device. In another variant, the plurality of computer-readable instructions are further configured to, when executed by a processing apparatus: receive data indicative of a parameter associated with the volatile memory device; evaluate the received data indicative of the parameter; and based at least on the evaluation, (i) cause selection of a different one of the second data from the data structure; and (ii) cause operation of the volatile memory device with a refresh rate associated with the selected different one of the second data.

In a further aspect, a method for operating a volatile memory device is disclosed. In one embodiment, the method includes: initiating a timer for the volatile memory device; operating the volatile memory device without refresh operations until expiration of the timer; and replacing memory contents located within the volatile memory device after the expiration of the timer.

In one variant, the timer is separate from a refresh counter associated with at least one of the volatile memory device or a controller of the volatile memory device; and the operating the volatile memory device without refresh operations includes operating the volatile memory device without use of the refresh counter.

In another variant, the initiating a timer for the volatile memory device includes initiating a timer which has been configured based on at least one of: (i) an access pattern, or (ii) an error tolerance.

In another variant, the method further includes adjusting of the length of time for the timer based at least on a prescribed bit error rate (BER) for the volatile memory device.

In another variant, the initiating of the timer for the volatile memory device occurs responsive to a disabling of the refresh operations for the volatile memory device.

In a further variant, the initiating of the timer for the volatile memory device occurs responsive to a loading of data within the volatile memory device.

In an additional aspect of the disclosure, computer readable apparatus is described. In one embodiment, the apparatus includes a storage medium configured to store one or more computer programs to be used with dynamically or probabilistically refreshed memory. In one embodiment, the apparatus includes a program memory or HDD or SSD on a computerized device such as a host device using probabilistic refresh technology.

In another aspect, an integrated circuit (IC) device implementing one or more of the foregoing aspects is disclosed and described. In one embodiment, the IC device is embodied as volatile memory device. In another embodiment, the IC device is embodied as a volatile memory device with integrated memory controller. In another embodiment, an ASIC (application specific IC) is used as the basis of at least portions of the device. In yet another embodiment, a chip set (i.e., multiple ICs used in coordinated fashion) is disclosed. In yet another embodiment, the device includes a multi-logic block FPGA device, such as for supplying logic for probabilistic control and refresh of volatile memory devices.

These and other aspects shall become apparent when considered in light of the disclosure provided herein.

### BRIEF DESCRIPTION OF THE DRAWINGS

FIG. 1 is a block diagram illustrating a general architecture for a system that includes partitioned memory arrays, in accordance with the principles of the present disclosure.

FIG. 1A is a plot of exemplary bit error rate (BER) as a function of refresh interval length for an exemplary volatile memory device, in accordance with the principles of the present disclosure.

FIG. 2 is a functional block diagram illustrating another exemplary architecture for a memory system that includes multiple memory chips, in accordance with the principles of the present disclosure. FIG. 3 is a block diagram of a memory device that includes partitioned memory arrays, in accordance with the principles of the present disclosure.

FIG. 4 is a block diagram of a system for use with, for example, the memory device illustrated in FIGS. 1 and 2, in accordance with the principles of the present disclosure.

FIG. 4A is a graphical representation illustrating an exemplary BER characteristic as a function of temperature.

FIG. 5 is a logical representation of a system for use with, for example, the memory device illustrated in FIGS. 1, 2 and 4, in accordance with the principles of the present disclosure.

FIG. 6A is a logical flow diagram of one exemplary embodiment of a method for operating a memory device/memory array, in accordance with the principles of the present disclosure.

FIG. 6B is a logical flow diagram of a second exemplary embodiment of a method for operating a memory device/memory array, in accordance with the principles of the present disclosure.

FIG. 6C is a logical flow diagram of a third exemplary embodiment of a method for operating a memory device/memory array, in accordance with the principles of the present disclosure.

FIG. 6D is a logical flow diagram of a fourth exemplary embodiment of a method for operating a memory device/memory array, in accordance with the principles of the present disclosure.

FIG. 6E is a logical flow diagram of a fifth exemplary embodiment of a method for operating a memory device/memory array, in accordance with the principles of the present disclosure.

FIG. 6F is a logical flow diagram of a sixth exemplary embodiment of a method for operating a memory device/memory array, in accordance with the principles of the present disclosure.

FIG. 6G is a logical flow diagram of a seventh exemplary embodiment of a method for operating a memory device/memory array, in accordance with the principles of the present disclosure.

FIG. 6H is a logical flow diagram of an eighth exemplary embodiment of a method for operating a memory device/memory array, in accordance with the principles of the present disclosure.

FIG. 6I is a logical flow diagram of a ninth exemplary embodiment of a method for operating a memory device/memory array, in accordance with the principles of the present disclosure.

FIG. 7 is a logical flow diagram of an exemplary embodiment of a method for replacing the contents of a memory device/memory array based on validation, in accordance with the principles of the present disclosure.

FIG. 8A is a graphical illustration of a prior art Ethash algorithm.

FIG. 8B is a logical block diagram of a prior art apparatus configured to search for proof-of-work (POW) with the Ethash algorithm of FIG. 8A.

FIG. 8C is a graphical illustration of a prior art process by which proof-of-work (POW) that is generated by an Ethereum miner can be used in the context of the blockchain-based shared ledger.

FIG. 8D is a graphical illustration of a prior art process by which proof-of-work (POW) that is generated by an Ethereum miner cannot be used multiple times in the context of the blockchain-based shared ledger.

FIG. 8E is a graphical illustration of a prior art process by which proof-of-work (POW) that is verified by a community of miners can be added to the blockchain-based shared ledger.

FIG. 9A is a logical block diagram of a first exemplary embodiment of an apparatus configured to search for proof-of-work (POW) with the aforementioned Ethash algorithm, in accordance with the present disclosure.

FIG. 9B is a logical block diagram of a second exemplary embodiment of an apparatus configured to search for proof-of-work (POW) with the aforementioned Ethash algorithm, in accordance with the present disclosure.

FIG. 9C is a logical block diagram of a third exemplary embodiment of an apparatus configured to search for proof-of-work (POW) with the aforementioned Ethash algorithm, in accordance with the present disclosure.

### DETAILED DESCRIPTION

Reference is now made to the drawings wherein like numerals refer to like parts throughout.

As used herein, the term “computer program” or “software” is meant to include any sequence of human or machine cognizable steps which perform a function. Such program may be rendered in virtually any programming language or environment including, for example, C/C++, Fortran, COBOL, PASCAL, Python, Ruby, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like, and may also include scripts, including without limitation those written in scripting languages.

As used herein, the term “memory” includes any type of integrated circuit or other storage device adapted for storing digital data including, without limitation, random access memory (RAM), pseudostatic RAM (PSRAM), dynamic RAM (DRAM), synchronous dynamic RAM (SDRAM) including double data rate (DDR) class memory and graphics DDR (GDDR) and variants thereof, ferroelectric RAM (FeRAM), magnetic RAM (MRAM), resistive RAM (RRAM), read-only memory (ROM), programmable ROM (PROM), electrically erasable PROM (EEPROM or EEPROM), DDR/2 SDRAM, EDO/FPMS, reduced-latency DRAM (RLDRAM), static RAM (SRAM), “flash” memory (e.g., NAND/NOR), phase change memory (PCM), 3-dimensional cross-point memory (3D Xpoint), and magnetoresistive RAM (MRAM), such as spin torque transfer RAM (STT RAM).

As used herein, the terms “microprocessor”, “processor” or “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable computer fabrics (RCFs), array processors, secure microprocessors, and application-specific integrated circuits (ASICs). Such digital processors may be contained on a single unitary IC die, or distributed across multiple components. Moreover, such processors may be integrated into one or more other types of devices such as e.g., memory devices.

Overview

In one exemplary aspect, the present disclosure provides for improved methods and apparatus for the implementation of accesses and refreshes in volatile memory devices, including where the accesses may need to be distributed (e.g., based on random or pseudo-random criteria). Advantageously, through implementation of such methods and apparatus, increased memory device performance can be achieved; e.g., memory device “dead” times associated with prior art refresh schemes discussed supra can be reduced or even eliminated, thereby making the memory device available for higher throughput/bandwidth.

At a high level, various aspects of the disclosure leverage, inter alia, the fact that each memory cell in a device (or array of devices) may have somewhat different characteristics and in fact dissipate charge at a different rate.

In various embodiments, random memory access over a search space may be probabilistic, as may the refresh operations. For instance, in one variant, memory accesses over a search space may be characterized in terms of probability density and/or error tolerance; e.g., some parts of a memory may have a higher probability of being used than others, and some parts of a memory may have a higher error tolerance than others.

In an exemplary implementation, a memory device is provided which allows, inter alia, the memory device to be selectively optimized for a given application, such that the memory bandwidth is improved and/or that power consumption is minimized as compared with prior, largely inflexible memory architectures. For instance, embodiments are disclosed herein which enable the memory device to flexibly alter its configuration during application run-time so as to further optimize its operation, especially in instances in which the memory requirements may change over time, and/or are tolerant to such configuration changes. In one exemplary approach, memory devices are disclosed which may selectively disable or enable memory refresh operations (or aspects thereof). For example, in applications where the data stored within the memory device may be expected to be stored and consumed within a prescribed period of time (e.g., in Ethereum-based applications, or video buffering applications), the memory device may disable memory refresh operations so as to maximize memory throughput and minimize power consumption by the memory device. Other portions of the same memory device (or differing memory device) may enable memory refresh operations, such as where the data stored within these other portions of the memory device are required to be preserved.

Combinations of the foregoing techniques are also disclosed which may be employed so as to further enhance the design and operational flexibility for the underlying memory device, including e.g., tailoring the applied configuration for a given application, and alteration of the operating characteristics when another application is invoked.

Specific operating examples are also disclosed for which the inventive memory devices described herein may be more suitable than prior memory device architectures. For example, memory device architectures that are optimized for blockchain-based cryptocurrency type applications, and in particular, for use in proof-of-work (POW) mining applications are disclosed. Advantageously, some exemplary embodiments of the methods and apparatus consume less power and increase memory bandwidth (throughput); thereby facilitating their adoption and implementation within power constrained, or otherwise power-sensitive (or power-managed), computing devices.

Yet other exemplary implementations are described, including: (i) use of a known temperature dependency by the memory controller as a basis for “intelligently” choosing not to probabilistically refresh; (ii) selective refresh by the memory controller for only what was missed in a prior probabilistic refresh; (iii) selective offload of comparatively slower refreshes to software; (iv) selective reduction of error correction for certain types or configurations of memory (e.g., 3D Xpoint™); (v) enablement of “latency amortization” or certain applications (e.g., bulk mining); (vi) mixture or combination of homogeneous or heterogeneous memory fetches within memory searches, e.g., to maximize for one or more relevant parameters (such as where each of the memory fetches can be parallelized via allocation to a separate core and/or pipelined, so as to spread out latency associated with each fetch); (vii) repurposing of extant unused mechanisms such as to provide more data bits per fetch (e.g., when ECC is unused, its bits can be used for another purpose); and (viii) “overfetching” of memory fetches to maximize relevant parameters; e.g., the media bandwidth of the memory is in effect wasted to optimize an associated memory controller's bandwidth.

Detailed Description of Exemplary Embodiments

Exemplary embodiments of the apparatus and methods of the present disclosure are now described in detail. While these exemplary embodiments are primarily described in the context of their use in e.g., cryptocurrency mining or other such applications, it would be readily apparent to those of ordinary skill that the present disclosure is not so limited. For example, the memory devices described herein have broader utility than the exemplary proof of work (POW) cryptocurrency mining applications. In fact, the memory devices described herein may be readily used in applications where the memory space is read in a uniform manner so as to ensure that the memory is, for example, probabilistically (as opposed to deterministically) refreshed. As used herein, the term “deterministically refreshed” relates without limitation to refresh operations which are based on a prescribed or a priori known relationship of variables. In contrast, a probabilistic refresh relates without limitation to refresh which occurs on an unspecified or indeterminate relationship of variables. It will be further appreciated that while certain steps and aspects of the various methods and apparatus described herein may be performed by a human being, the disclosed aspects and individual methods and apparatus are generally computerized/computer-implemented. Computerized apparatus and methods are necessary to fully implement these aspects for any number of reasons including, without limitation, commercial viability, practicality, and even feasibility (i.e., certain steps/processes simply cannot be performed by a human being in any viable fashion).

Other features and advantages of the present disclosure will immediately be recognized by persons of ordinary skill in the art with reference to the attached drawings and detailed description of exemplary embodiments as given below.

Exemplary Configurable System Apparatus/Architecture

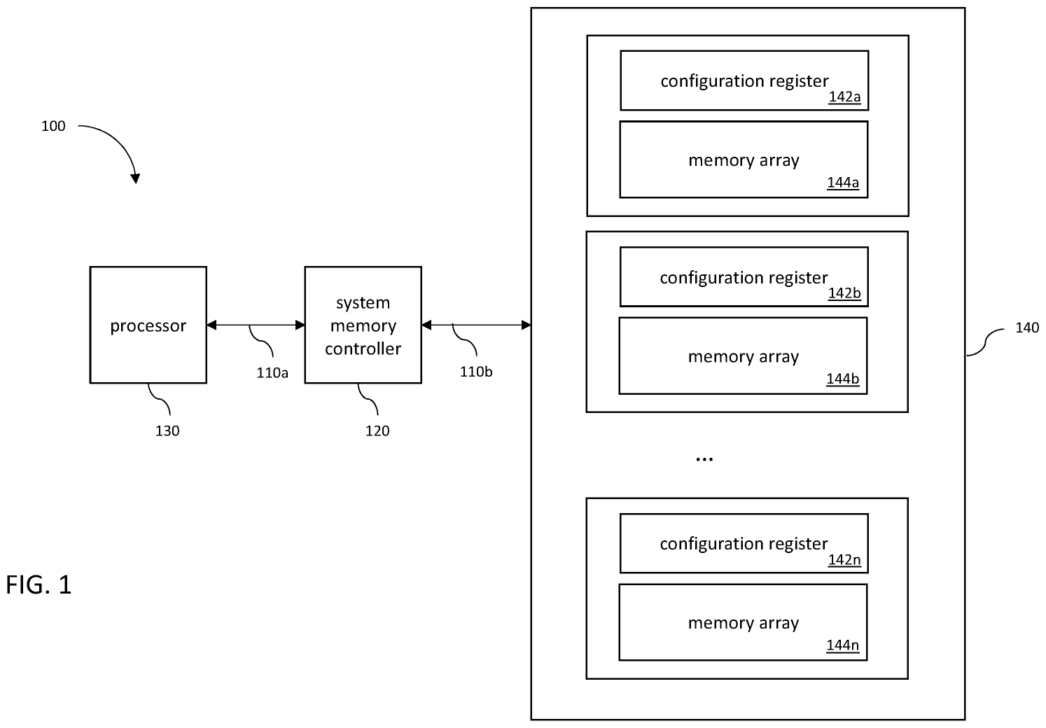

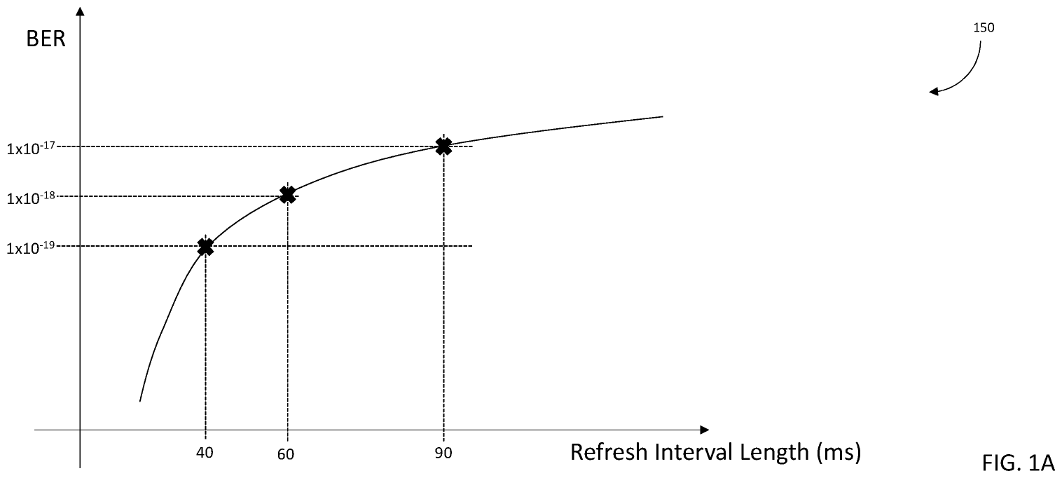

FIG. 1 is a block diagram illustrating a generalized architecture for a system 100 that includes “configurable” partitioned memory arrays 144 in accordance with the principles of the present disclosure.

As a brief aside, extant general compute paradigms for memory operation (including refresh) tend to ignore the underlying physical memory mechanism of DRAM storage; i.e., that reliability is a function of time between refreshes for DRAM. Certain types of applications use DRAM memory for very short storage times (sub-60 ms), and in a predictable manner. For example, standard cinematic video is shot at 24 frames/second; i.e., every video frame has a lifetime of ˜42 ms. Thus, the data in a video frame potentially has a shorter lifetime than DRAM memory cell refresh, dependent upon how that video frame information is stored on, and read from, the underlying memory device (which is typically in a highly uniform and deterministic manner). As a result, DRAM memory can be used without refresh with no adverse effect in certain aspects of video applications. This is to be contrasted with, for instance Ethereum (discussed in detail below); memory under an Ethereum mining application is probabilistically consumed (e.g., 2.5 Gb internal bandwidth over a 700 GB space results in a “read/refresh” on average once every 60 ms)—however since the read is random, some parts could be refreshed back to back (within a few milliseconds) and other parts could be refreshed at much greater intervals (e.g., up to 120 ms).

Additionally, some other types of applications can tolerate higher BER. For instance, so-called “error-tolerant” computing (also sometimes referred to as “error-resilient”) refers to computing which assumes and/or allows for the presence of some noise and/or errors in memory and/or data. As will be recognized by the artisan of ordinary skill given this disclosure, there are many applications for probabilistic computing, stochastic computing, and/or other types of error-tolerant computing with which the configurable apparatus and associated methodologies described herein may be used.

Returning to FIG. 1, the illustrated embodiment of the configurable system 100 may include a processor 130 (e.g., a microprocessor, digital processor, etc.) that is coupled with a memory device 140 via, for example, a communications interface 110. The communications interface 110 may include any number of suitable computing bus architectures such as, for example, system bus architectures or even any number of input/output (I/O) bus architectures which are commonly used to connect various peripheral devices to one or more processors.

In some implementations, a system memory controller 120 may assist in communications between the processor 130 and the memory device 140 (as shown). In other implementations, system memory controller functionality is subsumed within either the processor 130 or the memory 140. In FIG. 1, the processor 130 is coupled to the system memory controller 120 via communications interface 110a, while the system memory controller 120 is coupled to the memory device 140 via communications interface 110b. The system memory controller 120 may include a digital circuit that manages the flow of data going between the processor 130 and the memory device 140. In other words, the system memory controller 120 may assist in managing the flow of data going to/from respective ones of the memory arrays 144. For example, the system memory controller 120 may include firmware (e.g., a memory driver) that allows applications running on the processor 130 to communicate with the memory device 140 regardless of the memory technology.

As a brief aside, memory controllers include the technology specific logic necessary to connect to a memory device. For example, a DRAM memory controller will convert a memory access (e.g., a memory-mapped input/output (MMIO) address) into row and column addressing that is specific to the DRAM memory. Also, DRAM memory quickly loses its capacitive charge. Thus, a DRAM memory controller may also perform the required refreshing to ensure that data remains valid (i.e., processor doesn't need to refresh the DRAM). In another such example, a flash memory controller will convert a MMIO access into the appropriate erase-before-write instructions that are specific to the flash memory. Flash memory may also require “wear-leveling” to prolong flash memory life; consequently, a flash memory controller may periodically move data contents to different physical memory locations (that use the same logical MMIO address). Artisans of ordinary skill in the related arts will readily appreciate that virtually all memory technologies have different interface requirements; the memory controller 120 can present a common interface to the processor 130 so as to abstract and offload memory technology idiosyncrasies from the processor 130.

Referring back to FIG. 1, the memory device 140 may be partitioned into a plurality of memory arrays (144a, 144b, . . . , 144n). In one exemplary embodiment of the present disclosure, individual ones of these memory arrays may be operated independently from other ones of the other memory arrays. For example, a first memory array may be operated independently from a second memory array. In some implementations, this independent operation may be characterized by differing operating parameters. In another example, memory array may operate as a memory array having a first refresh rate, while other memory arrays may have a different refresh rate. Further, auto-refresh and self-refresh operations may be modified to have different looping structures. In one implementation, a first refresh loop may include the entire address space of a memory chip, and a second refresh loop may include only part of the address space of the memory chip. In another implementation, a first refresh loop may range over one portion of the address space of a memory chip and a second refresh loop may range over a second, different portion of the address space. Other common examples of operational parameters may include e.g., memory cell operation (e.g., single ended versus differential), error correction, temperature, power, clocking, word-size, etc.

As such, it will be appreciated by those of ordinary skill that variations in these parameters may result in different probabilities and/or error rates. For instance, a slower refresh allows for greater cell discharge of capacitance (and hence potentially more errors). A temperature outside prescribed operating ranges may accelerate cell capacitive discharge as well.

As used in the present context, the term “independent” refers to a memory device having memory arrays isolating one or more of the clock domain, power domain, refresh circuitry, error correction circuitry, configuration registers, and/or memory cells. An independent memory array is isolated so as to allow a processor to access the array differently from other memory arrays in the memory device.

In an exemplary embodiment, the memory arrays 144 may be homogenous in operation. For example, each of the memory arrays 144 may disable (or not possess) refresh circuitry. Rather, each of the memory arrays 144 may rely instead on, for example, a uniform and/or random read of individual ones of its memory cells in order to refresh its contents. In other words, reading the memory device 140 in a uniform and/or random manner may provide the “refresh” capabilities of the memory device 140 in a probabilistic manner. A uniform read (or write) may for example treat all memory areas as equal or accessible (aka, be “uninformed”), but the actual cells or portions of the array chosen for an individual access may be highly randomized (e.g., determined based on the user's actions, OS scheduler, etc.) and uncorrelated. Conversely, a non-uniform read, while it may be random in nature, may not treat all memory areas as equal, or otherwise not weight their results equally.

As a brief aside, refresh cycles consume a significant amount of internal bandwidth, as during these refresh cycles, the memory device 140 may not be accessible for normal read/write operations. For example, “general compute” memory devices (or “first-class” memory devices) may guarantee a maximum bit error rate (BER) of e.g., 1 E-18 under standardized operating conditions (e.g., room temperature, voltage, current, humidity, etc.). However, the refresh cycles associated with a general compute memory device may consume approximately 40% of the memory device's internal bandwidth in some circumstances. Accordingly, by disabling (or not possessing) refresh capabilities, a memory device may possess an additional 40% of available bandwidth for normal read and write operations.

As another example, each of the memory arrays 144 may disable refresh and rely instead on non-uniform read (e.g., one with a targeted search space as described subsequently herein) of individual ones of its memory cells in order to refresh its contents.

As yet another example, error-tolerant applications may utilize refresh rates (or alternatively, refresh via the aforementioned uniform/non-uniform probabilistic read approaches) which produce an acceptable level of errors. As such, the level of error tolerance may be specifically tied to the individual application scenario or read/refresh technique parameters so as to achieve or exceed the desired minimum level of error tolerance.

The various memory arrays 144 illustrated in FIG. 1 may further include one or more configuration registers 142—implemented in one variant using static random-access memory (SRAM)—associated with the memory arrays 144. These individual configuration registers 142 may be associated with a respective memory array 144, may be associated with the memory arrays 144 as a whole, or may be associated with one or more given subset(s) of the memory arrays 144. In some implementations, these configuration registers 142 may be used to reconfigure individual ones of the memory arrays 144. For example, some values for a given configuration register 142a (or a given number of configuration registers) may be associated with memory array 144a. Dependent upon the value loaded into the configuration register(s), the behavior of memory array 144a may change. For example, one value may turn off refresh for memory array 144a, another value may turn on refresh for memory array 144a at a first refresh rate, yet another value may turn on refresh for memory array 144a at a second refresh rate that occurs more frequently than the first refresh rate, and so on. In alternative embodiments, the plurality of memory arrays may be statically set or “hardened” with a set of operational parameters. For instance, a first memory array may have a preset first refresh rate, and a second memory array may have a second preset refresh rate.

As used in the present context, the term “hardened” as related to semiconductor devices refers to parameters that are fixed at the time of memory device manufacture. Examples of hardening include e.g., inflexible circuit design, destructive programming (e.g., burning fuses which cannot be unburnt), and/or other permanent manufacture techniques.

It will also be appreciated that other schemes may be utilized consistent with the present disclosure. For example, in one variant, probability value data or error tolerance data may be written directly into registers, and the memory controller configured to internally manage the memory according to the written values. As such, the present disclosure contemplates implementations with logic on or associated with the memory controller which can read these registers and apply the specified refresh schemes in applicable cases, depending on the level of sophistication in its indigenous algorithms. Hence, the present disclosure contemplates a range of controller configurations which may use the techniques described herein, ranging from very “smart” controllers with extensive indigenous logic, to more limited controllers which in effect act as a minion of external logic such as that executing on the processor 130.

The aforementioned structure of the memory device 140 advantageously enables a user (or the “smart” controller alluded to above) to “tailor” operation of the memory device 140 in accordance with a designated application (or designated applications). For example, a user of memory device 140 may intend to use one or more of the memory arrays 144 in such a way that these one or more memory arrays 144 are read in a uniform random fashion (e.g., for proof-of-work (POW) mining in crypto-currency block chain type applications). The reading of individual memory cells within a volatile memory device 140 also constitutes a refresh of those individual cells. In other words, similar to the reading of individual memory cells within a memory device 140, memory refresh is the process of periodically reading information from an area of the memory device 140 and immediately rewriting the read information to the same area without modification. Accordingly, by reading one or more of the memory arrays 144 in a uniform random fashion, one may be able to disable refresh operations (or decrease the frequency of refresh operations) for these one or more memory arrays 144. As discussed elsewhere herein, during a refresh cycle, the memory device 140 is not available for normal read and write operations. Accordingly, these periodic refresh cycles introduce, inter alia, significant additional processing overhead, thereby diminishing the internal memory device bandwidth. While these refresh cycles may be necessary in order for the memory device to be operable at pre-established general computing error rates across a wide-swathe of applications, applications exist which do not necessarily require such low computing error rates.

Referring back to FIG. 1, exemplary embodiments of the present disclosure enable different memory arrays 144 contained within memory device 140 to operate differently. For example, a first memory array 144a may be compliant with a standard (e.g., JEDEC JESD79-4B DDR4), while a second memory array 144b may not be compliant with a standard. In other words, memory array 144a may be treated as a higher reliability memory over periods of time greater than 60 ms, while memory array 144b may be treated as a relatively lower reliability memory for periods of time greater than 60 ms or alternatively may be used within the 60 ms time frame without any reliability degradation. Even though a refresh cycle does not directly affect processor 130 performance, refreshing the memory 140 consumes memory access bandwidth and system memory controller 120 processing cycles. Thus reducing the refresh burden can indirectly improve overall system performance. In this manner, a single memory component can be tailored to optimize memory performance based on application requirements.

In addition to higher and lower reliability over periods of time, some implementations may introduce various gradations of reliability operation (e.g., refreshing on time scales that are longer than 60 ms, and mitigating the resulting data loss). FIG. 1A illustrates one example conceptually illustrating an empirically determined plot 150 of raw bit error rate (BER) as a function of refresh interval. As will be appreciated by those of ordinary skill, characterization of memory devices such as that shown in FIG. 1A may occur according to any number of different schemes, including: (i) characterization of each individual device; e.g., by incrementally lowering refresh rate and measuring BER; (ii) through characterization of an exemplary or representative subset of a class of devices (e.g., a single device or group of devices from a given manufacturing lot which has passed qualification or validation testing); (iii) through explicit knowledge of capacitance discharge rates for different cells or regions of the device (i.e., based on known properties of the underlying physical parameters which may cause bit errors), etc. Moreover, the characterization may be pursuant to a testing or validation regime, such as that applied to JEDEC-compliant memory devices.

It is further noted that the present disclosure contemplates use of varying “classes” of memory in some embodiments; e.g., (i) first-class or validated memory (i.e., that which has successfully passed stringent testing or validation evaluation, such as the ability to achieve 1E-18 BER or greater at a prescribed rate of refresh), and (ii) second-class or unvalidated memory (i.e., that which has failed testing for one reason or another, but which can still provide some minimum level of performance (e.g., to a BER of 1E-15 or greater at the same rate as the validated memory)). Advantageously, certain embodiments disclosed herein can utilize the “second-class” memory, such as in error-tolerant applications, whereas it previously would have been unusable due to prevailing “general compute” performance paradigms.

An application can intelligently use the memory performance characteristics to select a refresh rate that both (i) minimizes memory bandwidth for refresh while (ii) still providing acceptable reliability. For example, a first memory array may use a refresh rate (e.g., 60 ms) that results in low bit error rates (e.g., 1E-18) for the first memory array; however, a second memory array may use a refresh rate (e.g., 90 ms) that results in a slightly higher bit error rate than the first memory array (e.g., 1 E-17).

While the foregoing example is presented in the context of DRAM refresh, artisans of ordinary skill in the related arts will readily appreciate that most dynamic memory technologies may be selectively modified to increase or decrease volatility (BER as a function of time) so as to trade-off other memory performances. These and other variations would be readily apparent to one of ordinary skill given the contents of the present disclosure, the foregoing merely being exemplary.

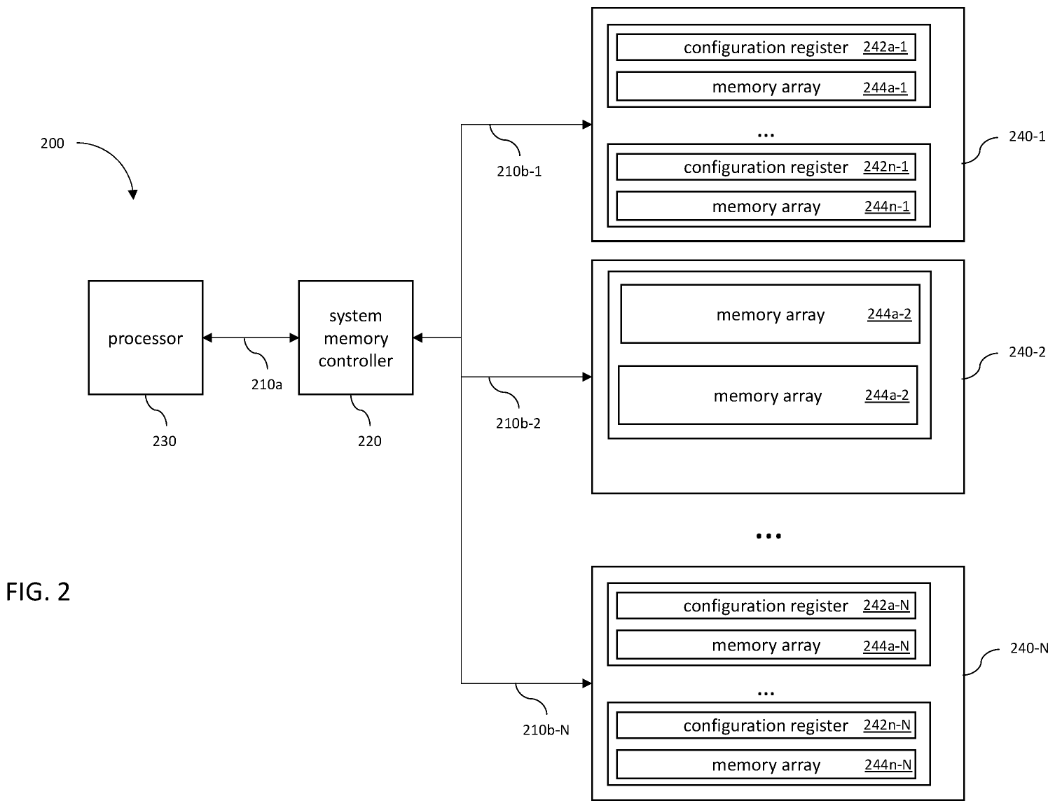

FIG. 2 is a functional block diagram illustrating exemplary architecture for a system 200 that includes multiple memory ICs or chips 240 (240-1 . . . 240-N), in accordance with the principles of the present disclosure. The system 200 may include a processor 230 that is coupled to multiple memory chips 240 via, for example, a communications interface 210. A system controller 220 may assist in communications between the processor 230 and the memory devices 240. In other implementations, system memory controller functionality is subsumed within either the processor 230 or the memory devices 240. In FIG. 2, the system memory controller 220 is coupled to multiple memory devices 240-1 . . . 240-N via respective communications interfaces 210b-1 . . . 210b-N. In some embodiments, individual memory controllers are coupled to individual memory devices.

Individual memory chips 240 may be partitioned into pluralities of memory arrays (244a . . . 244n) or have only a single memory array. In the example of FIG. 2, memory chip 240-1 is partitioned into a plurality of memory arrays (244a-1 . . . 244a-N) while memory chip 240-2 contains only a single memory array 244a-2. The above example is only illustrative, and various configurations of different types of memory chips may be used within the system architecture 20. In one implementation, all memory devices 240 are partitioned into pluralities of memory arrays. Referring back to FIG. 2, in some embodiments, the individual memory chips 240 may be operated independently from other memory chips 240. In one variation, a memory controller 230 can dictate that individual memory chips 240 of the same type (e.g., all DRAM) be operated at different refresh intervals.

Individual memory arrays within a memory chip may be operated independently from other memory arrays within the same memory chip. In some embodiments, some of the memory arrays within the same chip may be coupled together (e.g., have the same refresh rate, error correlation, clocking, etc.). In various embodiments, some memory arrays within different chips may be coupled together.

Similar to the system 100 (FIG. 1), the various memory arrays 244 illustrated in FIG. 2 may include one or more configuration registers 242 associated with the memory arrays 244. FIG. 3 illustrates one logical memory map 300 corresponding to an exemplary memory device. As shown in FIG. 3, the memory arrays 344 of the memory device 240 are mapped to linear spaces of a memory-mapped I/O (MMIO). Each of the memory arrays 344 may be fixed in size and addressing range. For example, memory array 342a is mapped to the memory address space 302a (0x10000000-0x1FFFFFFF); memory array 342b is mapped to the memory address space 302b (0x20000000-0x2FFFFFFF); . . . memory array 342n is mapped to the memory address space 302n (0xn0000000-0xnFFFFFFF).

In some implementations, a given memory array 344 (e.g., memory array 344a) may be dynamically configured via its corresponding configuration register 342 (e.g., configuration register 342a). In some such variants, the configuration registers may be addressed via out-of-band communication (e.g., a dedicated device bus, etc.). For example, the configuration registers may be programmed via a special mode setting that is accessed via pin configurations not normally used during operation. In other variants the configuration registers may be appended to or concatenated with the memory array space. In yet other variants, a configuration register space 304 is included as part of the MMIO (e.g., 0x00000000-0x0FFFFFFF). In this manner, the processor can directly read from and/or write to the configuration registers 342a, 342b, . . . 342n during operation. Still other variants for configuring memory may be substituted by artisans of ordinary skill given the contents of the present disclosure.

While the present discussion is presented within the context of a particular memory allocation scheme, other schemes may be substituted with success. Various operating parameters and their corresponding effects on operation are described in greater detail hereinafter.

Exemplary Memory Device

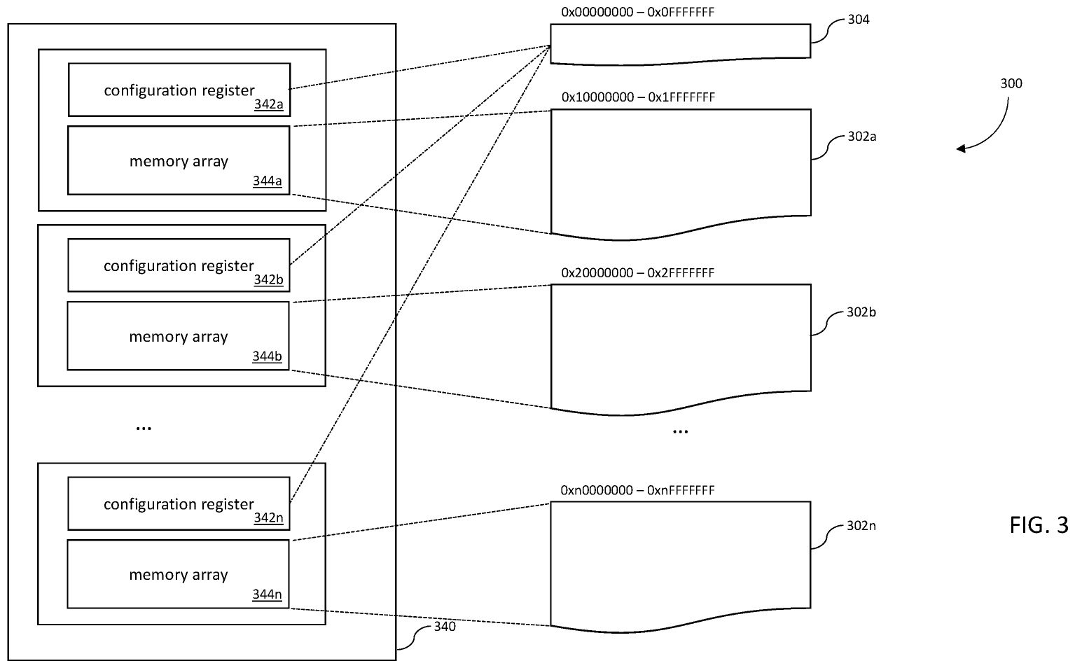

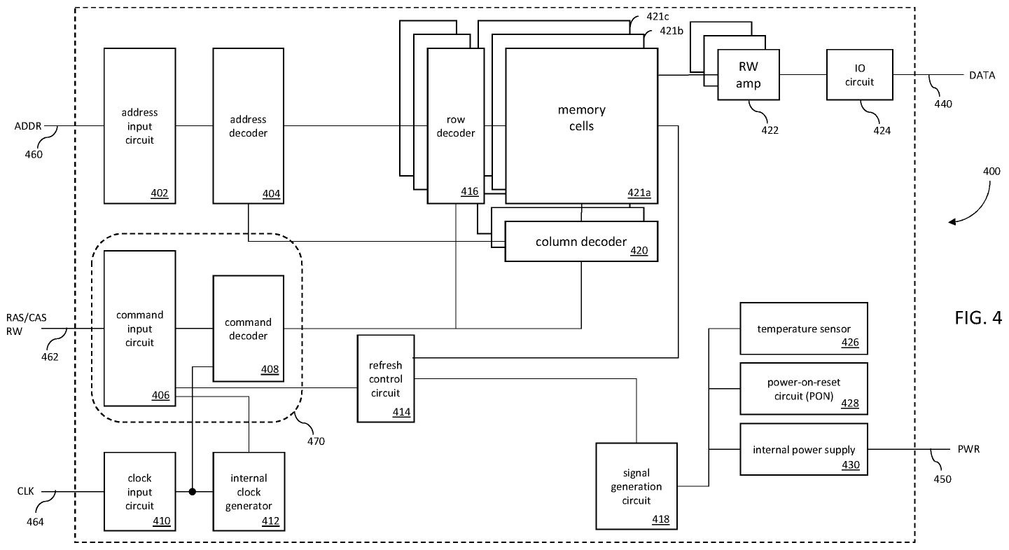

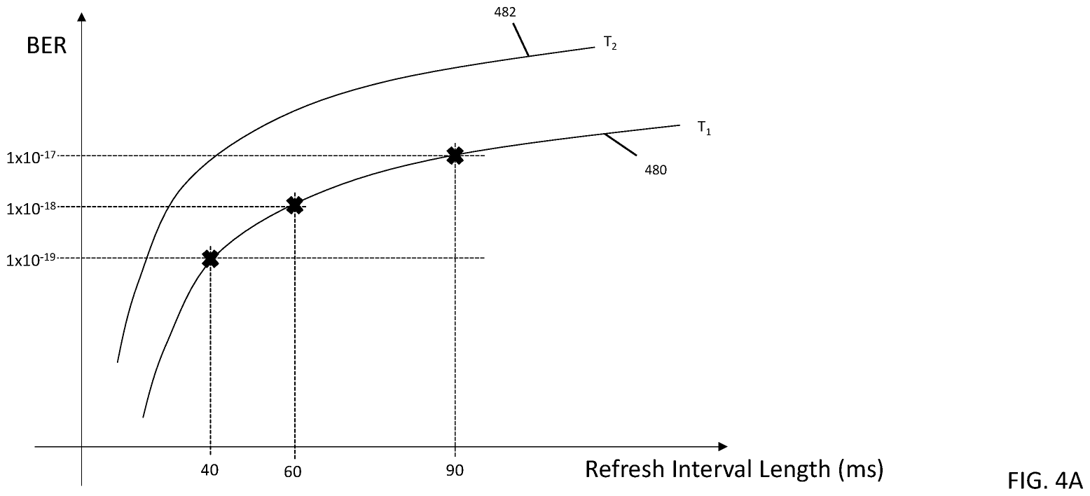

FIG. 4 is a logical block diagram of one exemplary implementation of a memory device 400 manufactured in accordance with the various principles of the present disclosure. The memory device 400 may include a plurality of partitioned memory cell arrays 421. In some implementations, each of the partitioned memory cell arrays 421 may be partitioned at the time of device manufacture. In other implementations, the partitioned memory cell arrays 421 may be partitioned dynamically (i.e., subsequent to the time of device manufacture). The memory cell arrays 421 may each include a plurality of banks, each bank including a plurality of word lines, a plurality of bit lines, and a plurality of memory cells arranged at, for example, intersections of the plurality of word lines and the plurality of bit lines. The selection of the word line may be performed by a row decoder 416 and the selection of the bit line may be performed by a column decoder 420.

The plurality of external terminals included in the semiconductor device 400 may include address terminals 460, command terminals 462, clock terminals 464, data terminals 440 and power supply terminals 450. The address terminals 460 may be supplied with an address signal and a bank address signal. The address signal and the bank address signal supplied to the address terminals 460 are transferred via an address input circuit 402 to an address decoder 404. The address decoder 404 receives, for example, the address signal and supplies a decoded row address signal to the row decoder 416, and a decoded column address signal to the column decoder 420. The address decoder 404 may also receive the bank address signal and supply the bank address signal to the row decoder 416 and the column decoder 420.

The command terminals 462 are supplied with a command signal to a command control circuit 470. The command control circuit 470 may include a command input circuit 406 and a command decoder 408. The command signal 470 may include one or more separate signals such as e.g., row address strobe (RAS), column address strobe (CAS) and/or read/write (R/W). The command signal input to the command terminals 462 is provided to the command decoder 408 via the command input circuit 406. The command decoder 408 may decode the command signal 462 to generate various control signals. For example, the RAS can be asserted to specify the row where data is to be read/written, and the CAS can be asserted to specify where data is to be read/written. In some variants, the RAN command signal determines whether or not the contents of the data terminal 440 are written to memory cells 421, or read therefrom.

During a read operation, the read data may be output externally from the data terminals 440 via a read/write amplifier 424 and an input/output circuit 424. Similarly, when the write command is issued and a row address and a column address are timely supplied with the write command, a write data command may be supplied to the data terminals 440. The write data command may be supplied via the input/output circuit 424 and the read/write amplifier 422 to a given memory cell array 421 and written in the memory cell designated by the row address and the column address. The input/output circuit 424 may include input buffers, in accordance with some implementations.

The clock terminals 464 may be supplied with external clock signals for synchronous operation (commonly used in e.g., Synchronous DRAM (SDRAM)). In one variant, the clock signal is a single ended signal; in other variants, the external clock signals may be complementary (differential signaling) to one another and are supplied to a clock input circuit 410. The clock input circuit 410 receives the external clock signals and conditions the clock signal to ensure that the resulting internal clock signal has sufficient amplitude and/or frequency for subsequent locked loop operation. The conditioned internal clock signal is supplied to feedback mechanism (internal clock generator 412) provide a stable clock for internal memory logic. Common examples of internal clock generation logic 412 includes without limitation: digital or analog phase locked loop (PLL), delay locked loop (DLL), and/or frequency locked loop (FLL) operation.

In alternative variants (not shown), the memory 400 may rely on external clocking (i.e., with no internal clock of its own). For example, a phase controlled clock signal may be externally supplied to the input/output (IO) circuit 424. This external clock can be used to clock in written data, and clock out data reads. In such variants, IO circuit 424 provides a clock signal to each of the corresponding logical blocks (e.g., address input circuit 402, address decoder 404, command input circuit 406, command decoder 408, etc.).

The power supply terminals 450 may be supplied with power supply potentials. In some variants (not shown), these power supply potentials may be supplied via the input/output (I/O) circuit 424. In some embodiments, the power supply potentials may be isolated from the I/O circuit 424 so that power supply noise generated by the IO circuit 424 does not propagate to the other circuit blocks. These power supply potentials are conditioned via an internal power supply circuit 430. For example, the internal power supply circuit 430 may generate various internal potentials that e.g., remove noise and/or spurious activity, as well as boost or buck potentials, provided from the power supply potentials. The internal potentials may be used in e.g., the address circuitry (402, 404), the command circuitry (406, 408), the row and column decoders (416, 420), the RW amplifier 422, and/or any various other circuit blocks.

A power-on-reset circuit (PON) 428 provides a power on signal when the internal power supply circuit 430 can sufficiently supply internal voltages for a power-on sequence. A temperature sensor 426 may sense a temperature of the semiconductor device 400 and provides a temperature signal; the temperature of the semiconductor device 400 may affect some operational parameters. For example, refresh rates may need to be adjusted as the temperature of the semiconductor device increases/decreases.

A signal generation circuit 418 may include one or more oscillator(s) that provides an oscillator reference signal based on e.g., the power on signal generated by the power-on-reset circuit (PON) 428 and the temperature provided by the temperature sensor 426. The signal generation circuit 418 may control intervals of oscillator reference signal responsive to the temperature signal (when enabled by the power on signal). For example, the signal generation circuit 418 may decrease the intervals of activation of the oscillator reference signal for more frequent refresh operations when the temperature is higher (e.g., responsive to the temperature signal indicating a higher temperature). The signal generation circuit 418 may also increase the intervals of activation of the oscillator signal for less frequent refresh operations, responsive to the temperature signal indicating that the temperature is lower.

The refresh control circuit 414 provides an internal reference signal for controlling refresh operations. In one embodiment, the refresh control circuit 414 receives the address reference signal from the command decoder 408, the clock enable signal from the command input circuit 406, and the oscillator reference signal from the signal generation circuit 418. For row based refresh, the row decoder 416 may receive the internal reference signal and increment a row address for refresh operations responsive to the internal reference signal. In alternative implementations (where refresh is based on columns rather than rows), the column decoder 420 may receive the internal reference signal and increment a column address for refresh operations responsive to the internal reference signal.

In one exemplary embodiment, various operational parameters associated with various ones of the memory arrays 421 may be controlled via the use of configuration registers. In other words, the use of these configuration registers may enable the tailoring of the memory arrays 421 for a given application (or applications), as discussed in greater detail below. These configuration registers may further enable the memory cell architectures themselves within the memory arrays to dynamically change. As previously discussed, various embodiments of the disclosure leverage the characteristics of probabilistic and/or error-tolerant operation as a basis for configuration and/or operation of the memory device. For example, in some error-intolerant embodiments, the memory controller includes logic configured to track what cells/portions of memory were or were not read/written (and thereby refreshed), so as to implement an “active” refresh scheme for the missed cells/portions. In this fashion, no portion of the memory device is allowed to exceed a prescribed maximum duration between refreshes. Conversely, in some error-tolerant embodiments, at least portions of the foregoing logic can be relaxed or even obviated (or if so equipped—such as in a multi-mode device—disabled), since errors arising from “missed” cells/portions can be tolerated, at least to a prescribed level.

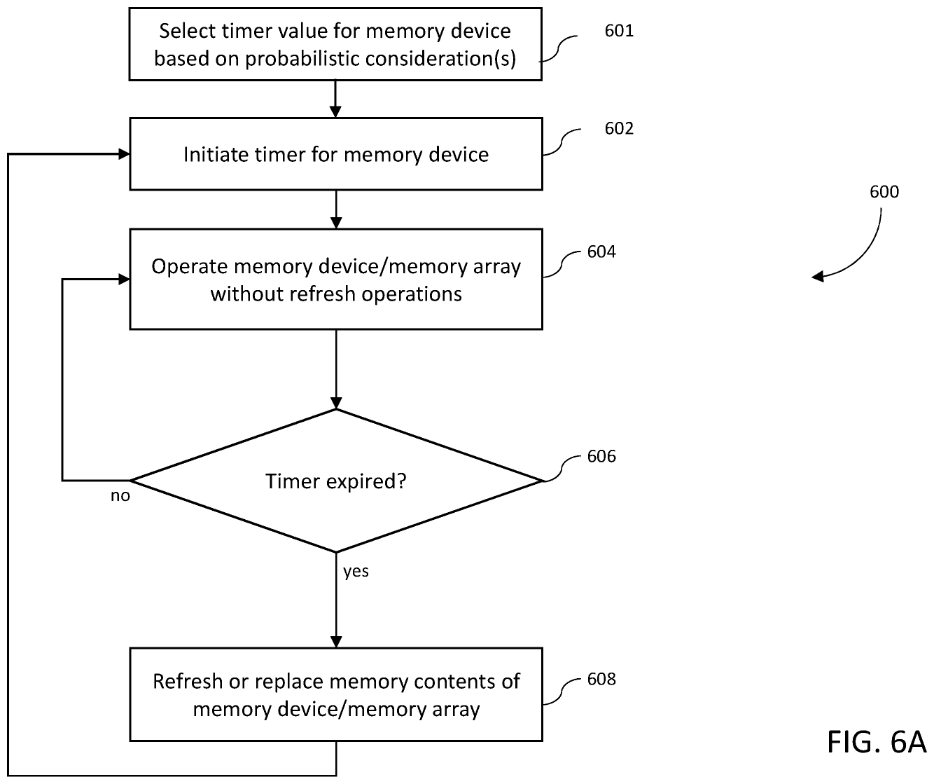

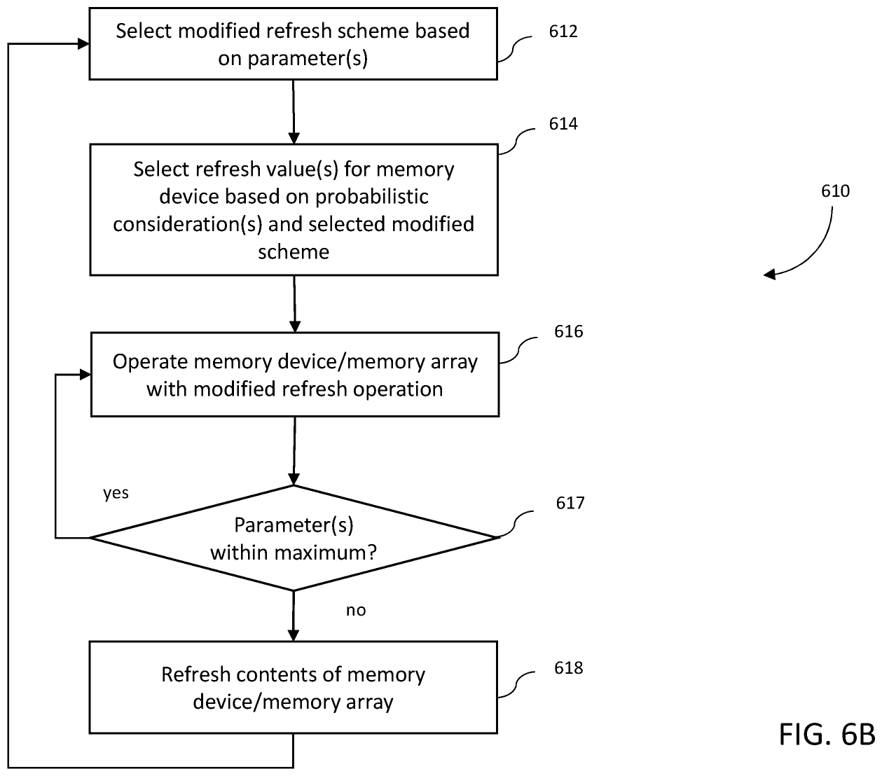

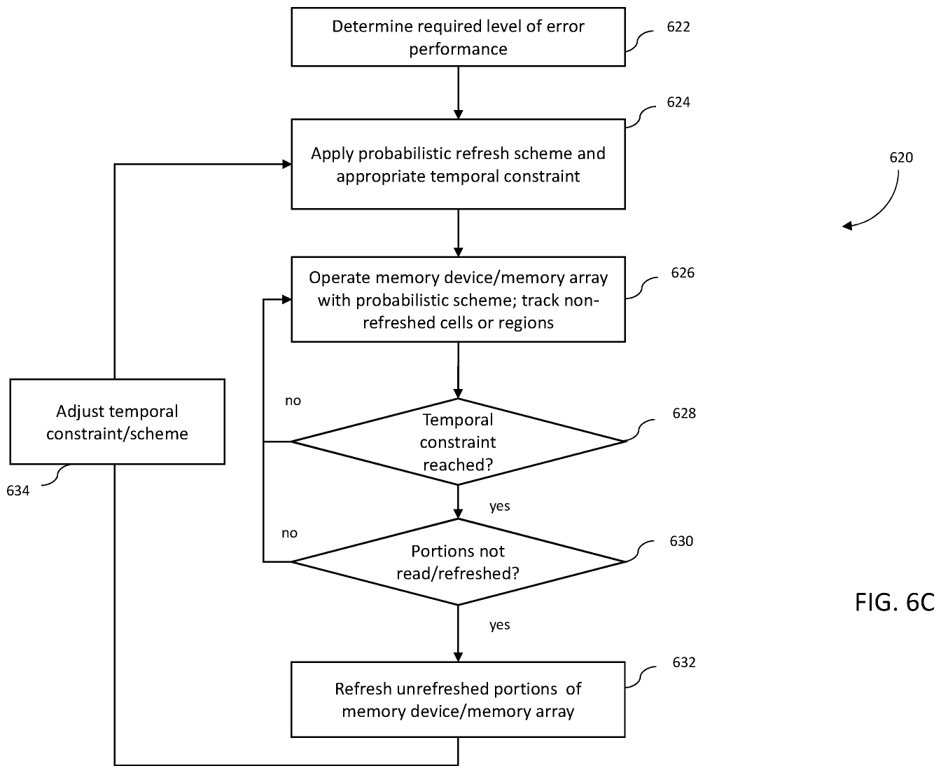

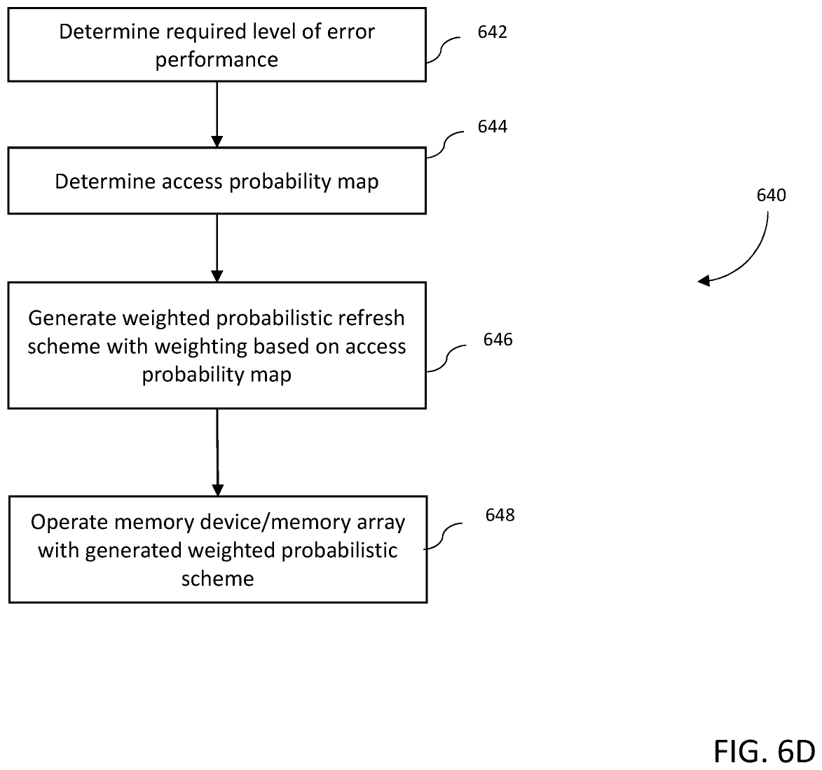

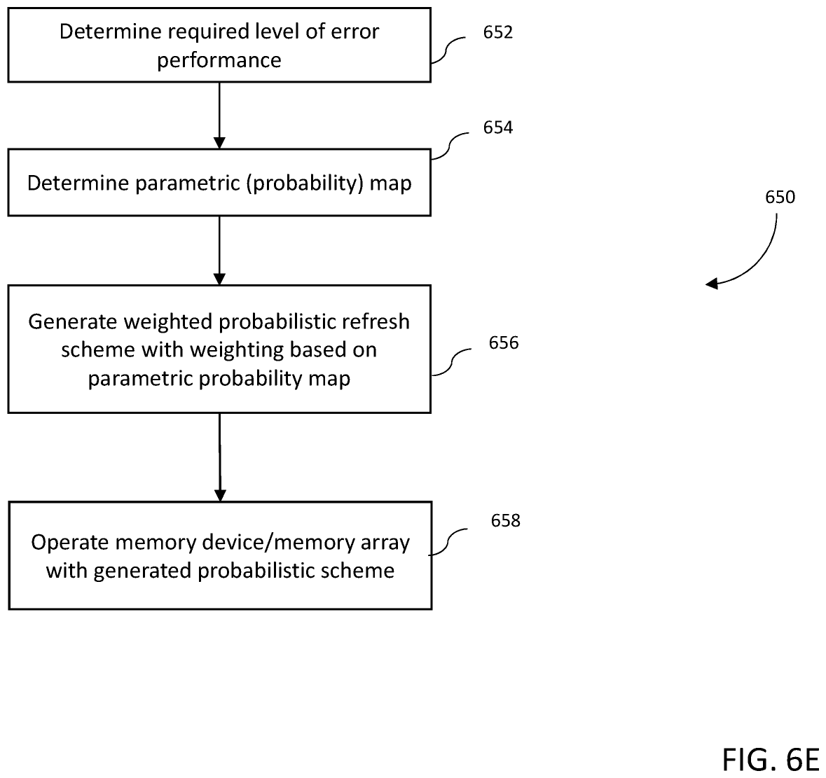

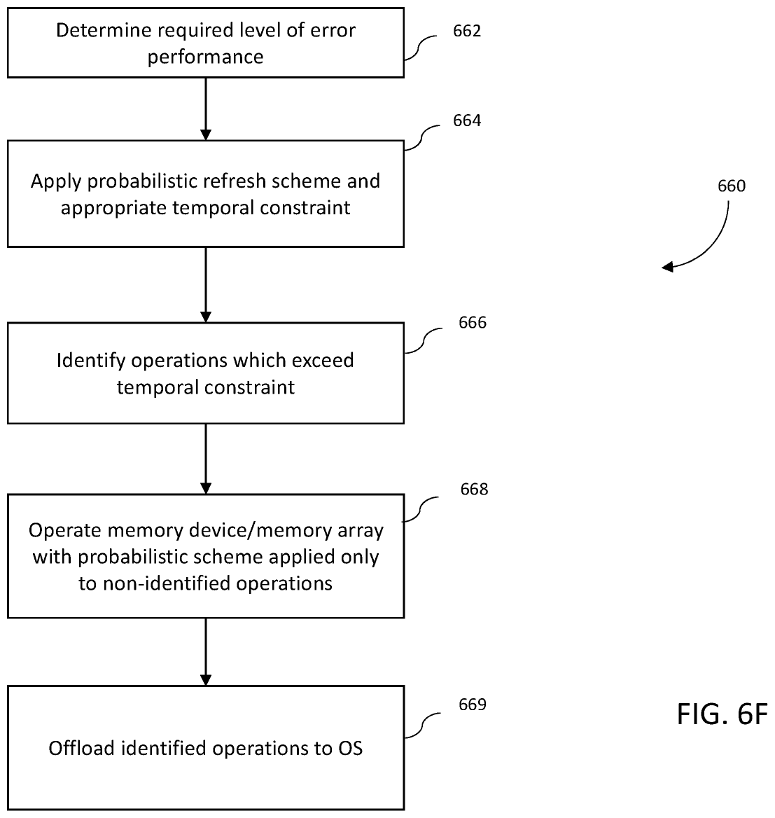

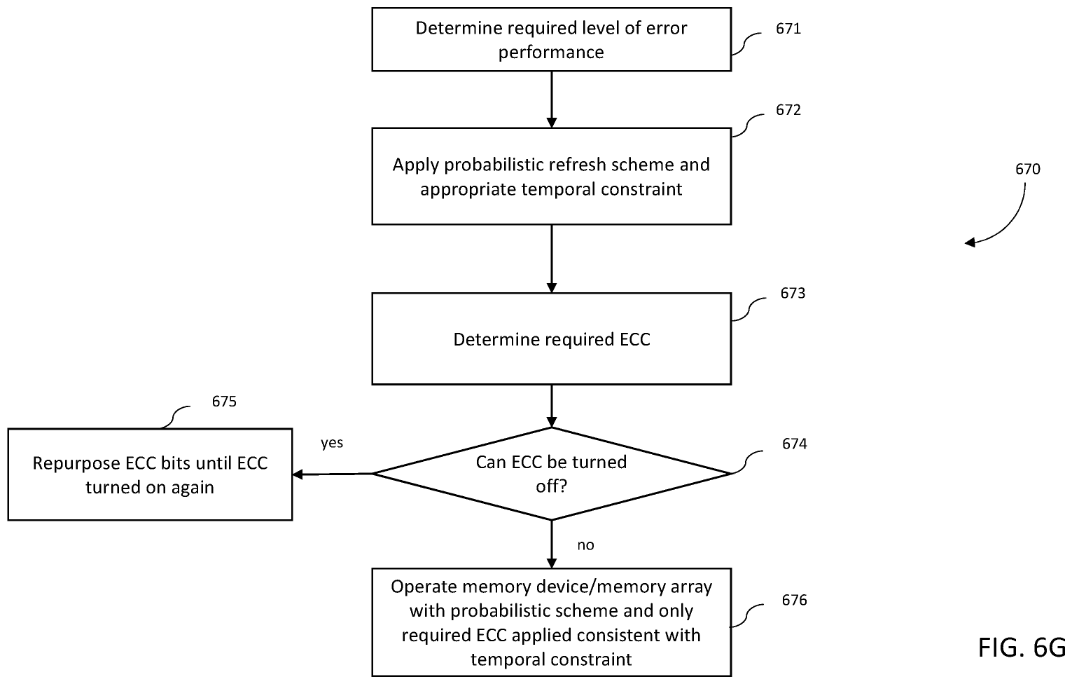

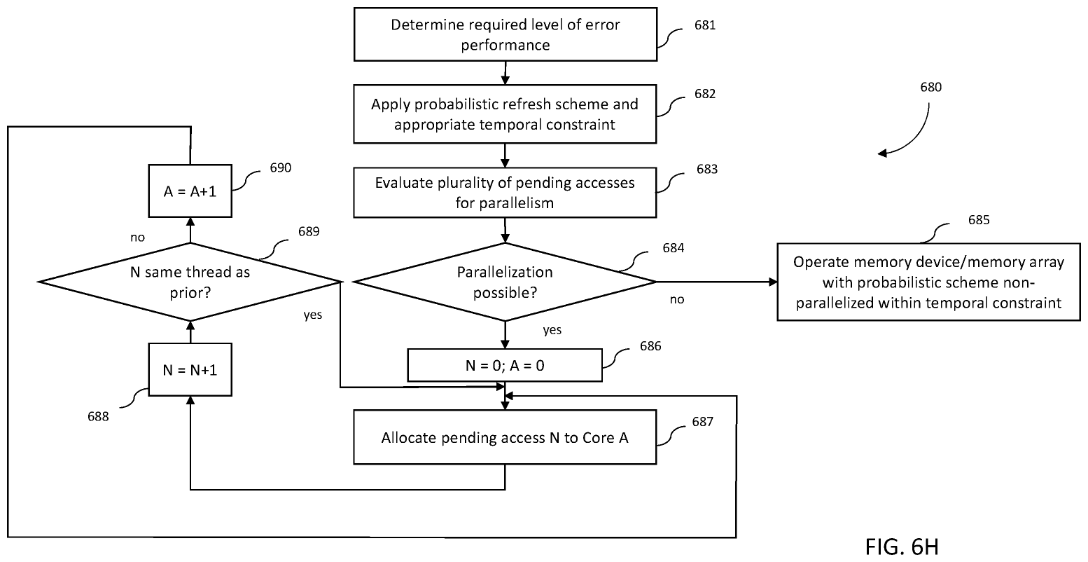

Moreover, prior probabilistic refreshes may be used as the basis for subsequent refreshes. For example, a prior probabilistic refresh operation may only refresh certain cells/regions of the device; as such, depending on the level of error tolerance, those cells/regions missed during the prior refresh may be identified and selectively refreshed, or not refreshed. See e.g., the exemplary method of FIG. 6C described subsequently herein.

Additionally, in embodiments utilizing uniform refresh, a weighting of different cells or portions of a memory array may be wholly unnecessary (since by definition there is a uniform scheme applied). Conversely, in non-uniform refresh embodiments (see e.g., the exemplary method of FIG. 6D), the memory controller is configured to weight refreshes according to a prescribed scheme. In one implementation, this scheme is proportional; i.e., based on a proportionality factor or metric. For instance, in a proportional use-based scheme (wherein the factor or metric is use or accesses to a given cell or portion), the controller will proportionately weight the refresh in heavily accessed areas more lightly (e.g., according to a direct/linear, or even non-linear proportion function), and conversely the more lightly accessed areas more heavily in terms of refresh (based on the assumption that the accesses refresh the accessed cells/portions).

In another such proportional scheme, a map of the energy dissipation of the various cells or regions of the device as a function of time is used as a basis for the proportionality weighting. Specifically, if the statistical characteristics of discharge rate of certain aggregations of cells (e.g., regions of the device) is known in advance, such data can be utilized by the controller in weighting subsequent refresh operations such that the more (statistically speaking) rapidly dissipating cells/regions are refreshed at a higher rate relative to those with lower dissipation rates.

Likewise, in yet other variants, the controller may be configured to weight the refresh operations according to one or more physical parameters (e.g., operational parameters such as temperature); see e.g., the exemplary method of FIG. 6E. As is known, the temperature experienced by different regions of a given device may vary significantly. As such, the statistical performance of each such region may be differentially affected by its temperature, and hence this can be correlated to the necessary refresh scheme/frequency applied. For instance, in one simplistic example, temperatures experienced within central regions of the device (i.e., away from the edges) may be different from those more peripheral to the device due to e.g., the presence or absence of heat dissipation area at the edges.

Yet further, less granular temperature data may be used as a basis for configuration or adjustment of the refresh parameters of the memory device. Specifically, in one variant, the device is characterized by a “global” temperature variation which has a known overall effect on BER (e.g., statistically over the entire device, as opposed to a per-cell or per-region basis). See, e.g., FIG. 4A, wherein the BER characteristic at a higher temperature T₂ 482 is shifted relative to that of a lower temperature T₁ 480, based on an overall device temperature (e.g., that monitored at one spot, or averaged). This data can be used to adjust the probabilistic refresh parameters described herein (e.g., shorter refresh periods on a statistical basis as compared to at the lower temperature).

In yet another implementation, device voltage is used as a basis of adjustment.

In yet another implementation, device frequency is used as a basis of adjustment. For instance, in one embodiment, a power-enabled device such as e.g., low-power dual-data rate (LPDDR) DRAM is utilized; instances where the clock is stopped, such as to save power, can be utilized as an input to the refresh adjustment/configuration process. As another example, for JEDEC timings, a host can change refresh (e.g., 2×, 4×, or even less), and as such can be used as an input to the controller. It is noted, however, that a calibration process may be involved in such changing of the clock/refresh, and as such this requirement may also be used as an input to the controller (e.g., if recalibration is known to be required for certain types of changes/operations, that knowledge may be used by the controller in structuring its refresh regime).

Yet other exemplary implementations are contemplated consistent with the present disclosure. For example, one contemplated scheme includes the selective offload of comparatively slower refreshes to software as opposed to hardware. As is known, hardware-based operations are significantly faster in general that software-based operations (e.g., those executed on a processor core/pipeline), and this can be leveraged to categorize different processing for a given refresh based on speed. For example, where a given refresh will only be required at a periodicity well below that available via hardware logic on the device (or well below the probabilistically specified refresh interval), such refreshes may be handed off to a software process executing on the memory controller (or the processor), which may even be a kernel-based process for the system in which the memory device is used. In contrast, faster refreshes may be handled directly within the hardware logic of the memory device. In one variant, different types of refreshes are pre-classified as belonging to a “slow” group or a “fast” group (e.g., to be executed in software or hardware respectively).

In yet a further implementation, selective reduction of error correction (e.g., on-device ECC) is applied via the memory controller for certain types or configurations of memory with certain attributes (e.g., 3D Xpoint™). For example, with 3D memory, the controller can be configured to use a different ECC/management schemes depending on the particular application and requirements. In another variant, the error correction is reduced to a prescribed level or by a prescribed amount (e.g., to a value on the order between normal values for say DRAM and an SSD). This prescribed level or amount may be determined based on, for instance, the selected probabilistic maximum BER for the application. For example, a selected BER on the order of 1 E-18 may require “full” ECC, while suitable results may be obtained through use of reduced ECC for lower BERs. In some cases, ECC can be completely obviated, such as where the probabilistic scheme—e.g., probabilistic reads/accesses to all relevant portions of the array or array portion—achieves at least the desired minimum level of BER performance.

In a further implementation, the present disclosure contemplates use of latency distribution or “amortization” for certain applications (e.g., bulk cryptocurrency or other mining). For example, in one such approach, a mixture or combination of homogeneous or heterogeneous memory fetches may be used within memory searches, so as to maximize for one or more relevant parameters such as total search time. In one implementation, each of the individual memory fetches are parallelized via allocation to a separate processor core (and/or pipelined within the same core), so as to distribute and ameliorate the latency associated with each fetch through parallelism. For instance, certain types of fetches may be more or less latent than others, and as such may “bottleneck”: the search as a whole or portions thereof; these can be selectively optimally structured relative to the other less latent fetches so that the target parameter is achieved (assuming proper coordination between the parallelized processes).

As one example of the foregoing, consider the application of bulk Ethereum mining, which can be performed in parallel by design (e.g., because every miner is searching the same memory space in parallel).As such, a miner could double his/her mining search to return a result in half the time; this approach scales proportionately (e.g., 4× parallelism returns the result in ¼ the time, and so forth). In other words, a miner that devotes N cores plus associated memory to a given mining task or process, can reduce average latency of the process as a whole by 1/N—provided that the searches are appropriately generated, cached, and mixed (i.e., so that two or more cores are avoiding wasteful or non-productive overlap, such as repetitively hitting the same spots in memory). Hence, as a practical outgrowth, this approach can further result in a uniform probabilistic refresh on the entire memory space that occurs N times faster than if not parallelized, since in effect each of the N cores is performing a unique portion of the total refresh of the array in parallel.

It will also be appreciated that the foregoing parallelism can be scaled or balanced as needed with other considerations, such as where speed (time to completion) is traded off with maintenance of one or more other parameters of interest, such as temperature, error, etc. For instance, where a higher error rate can be tolerated, the parallelism can be reduced so as to achieve the desired level; e.g., such that the uniform probabilistic refresh occurs at a rate sufficient to only produce the occasional error consistent with the tolerance level.

In still a further implementation, extant unused mechanisms within the memory device (and/or controller) can be “repurposed” when their use/function is obviated. For example, when ECC is turned off or reduced, its associated data bits can be used so as to provide more data bits per fetch, thereby increasing fetch efficiency. See, e.g., the exemplary method of FIG. 6G discussed below.

In a further implementation, “overfetching” of memory fetches is used by the memory controller to maximize or optimize one or more relevant parameters. In the present context, the term “overfetching” refers without limitation to the fetching of data from the memory device that is outside the bounds of the request presented to the controller. For example, a single request may activate numerous bit-lines in a DRAM device, only to return a single cache line to the requesting CPU. This generally is associated with wasted energy on the memory device. However, where energy consumption is not a critical parameter (e.g., in server or other similar environments as opposed to mobile device applications), overfetch can be selectively used to accomplish refresh-related goals such as optimization of one or more parameters. In one exemplary implementation, the memory controller includes an internal interface that accesses the “raw” data of the memory cells (pre-ECC). The memory controller's bandwidth can be described as a combination of accesses for data, and refresh accesses. Notably, as discussed above, refresh costs memory controller bandwidth because during refresh no data access is possible. The effective or external memory interface bandwidth can also be considered (i.e., post-refresh, post-ECC). Hence, in one exemplary scenario according to the present disclosure, data is overfetched (relative to the external interface), and unused or unrequested data discarded. The internal memory interface of the controller can be operated without explicit refresh in such case.

Accordingly, in a uniform probabilistic refresh scenario of the type previously described, the full bandwidth of the memory controller can be used, and the (intentional) overfetching relied upon as the refresh mechanism. Stated differently, overfetching at a sufficiently high rate (which can be correlated to the level of error tolerance as well as desired) can obviate internal refresh mechanisms of the device that would otherwise need be used, based on the refresh provided by the memory accesses (and subsequent re-write of the read cells for each of the accesses).

As described above, embodiments of the disclosure utilize random memory accesses over a prescribed search space that produce a probabilistic (refresh) result. If truly random, then over enough time, each cell will be read/refreshed. It will also be recognized, however, that memory accesses over a search space may be characterized in terms of probability density and/or error tolerance functions, including those which take different functional forms. For instance, some parts of the cell array may be utilized more often than others (due to, e.g., non-random functions or processes which preferentially utilize these portions, such as where memory in certain array locations is preferentially used because of an attribute of its location). As such, accesses may be characterized by e.g., a “white” Gaussian random distribution (uncorrelated), or a “colored” Gaussian random distribution (e.g., one with a prescribed covariance matrix in multiple dimensions, such as relative to the cell array dimensions). Data relating to such distribution may be used by the controller in one implementation to adjust or compensate for a given parameter associated with the refresh scheme. Non-uniform or highly skewed access schemes may for instance necessitate a faster or more stringent refresh regime, since portions of the array (probabilistically speaking) have a lower chance of a read/write (and associated refresh) over a given time. This skew (e.g., as reflected in one implementation by a covariance matrix) may be spatial, temporal, or a function of other parameters such as temperature or voltage.

Similarly, some parts of the cell array may produce errors at a (statistically) higher rate than others due to e.g., manufacturing variance or other factors; this variance may be characterized and utilized by the memory controller in configuration of its refresh scheme.

As noted, Ethereum generally assumes a uniform memory search, where every memory value is treated identically, and some error tolerance by the application is present. Conversely, as another example, artificial intelligence or machine learning applications may assume non-uniform memory searches (e.g., within a limited area of memory), and/or weigh memory “outlier” values more or less heavily, both in terms of results and refresh if desired.

Further, program execution memory may have a significant fraction of regions that are randomly “touched” (depending on e.g., unpredictable user activity), but the entire memory space is error intolerant (i.e., an error in program code would cause code execution errors or “crash” the software).

Exemplary Operating System Considerations

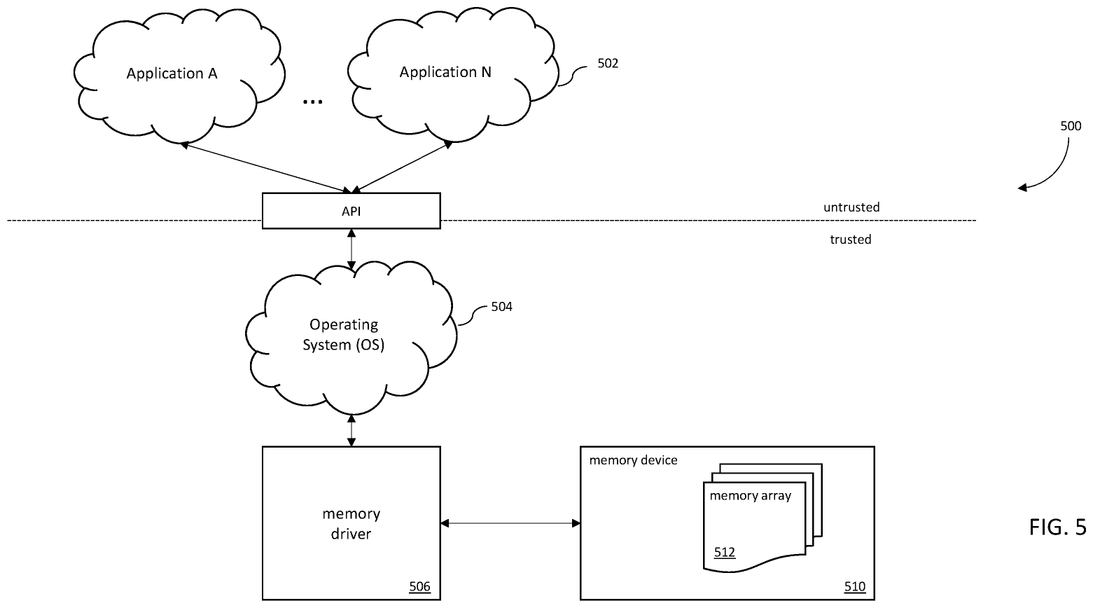

Referring now to FIG. 5, an exemplary computing system 500 configured in accordance with the various principles of the present disclosure is shown and described in detail. The exemplary computing system 500 may include, for example, desktop computers, laptop computers, tablets, smart devices (e.g., smart phones, smart watches, etc.), or literally any other device capable of executing computer-readable instructions. The computing system 500 functions (or operations) described herein may be implemented in hardware, software, firmware, or combinations of the foregoing. If implemented in software executed by a processor, the functions may be stored on, or transmitted over, as one or more instructions or code on a computer-readable apparatus (e.g., a computer-readable storage medium). Computer-readable media may include both non-transitory computer storage media and communication media including any medium that facilitates transfer of a computer program from one place to another. A non-transitory computer-readable apparatus may include any available medium that can be accessed by, for example, computing system 500.

The computing system 500 may include one or more applications 502. Generally speaking, applications operate within user space which may be considered untrusted. For example, the one or more applications 502 may include a third party application that generally would be untrusted by the computing system 500.

Third party applications are software applications that are generated or developed by parties that differ from the developer of the computing system 500. The one or more applications 502 may also include a second party application that may be trusted or untrusted.

Second party applications are software applications that are generated or developed by parties that are partially owned, or in otherwise close business relationships with, the developer of the computing system 500. The one or more applications 502 may also include a first party application that may be trusted or untrusted.

First party applications are software applications that are generated or developed by the manufacturer or developer of the computing system 500.

As used herein, the terms “privilege”, “privileged”, “non-privileged”, “trust”, “trusted” and/or “untrusted” in the context of computing systems refers to the protections or mechanisms implemented by a computer system or publisher to protect against faults and/or malicious behaviors. Trusted and/or privileged software may freely access system resources, whereas untrusted and/or non-privileged software may only access system resources under one or more constraints. In some cases, a computer operating system may provide multiple different levels of access to resources. The collection of special interfaces (application programming interfaces (APIs)) between trusted and untrusted software form a trust protocol that allows an untrusted application to access resources in a limited, secure manner. Gating access between trusted and untrusted access can improve security by preventing untrusted programs from misusing resources.

As used herein, the terms “user space” and “kernel space” refer to logical separations in software execution privileges. Processes running within the user space may only access a limited allocation of resources (limited by the kernel), whereas the kernel is trusted with system management and can access any system resource. Most secure computer systems restrict untrusted user space applications from modifying system operation in an unrestricted manner (such as memory operation). For example, within the context of the present disclosure, it would be highly undesirable for a malicious user space application and/or a faulty user space application to modify the configuration of a memory array that is used for a different application.

Referring back to FIG. 5, the one or more applications 502 (which are untrusted) may communicate with trusted software on the computing system 500 via, for example, APIs of an operating system (OS) 504. For example, a socket, port or interface may be opened or designated, which enables the application 502 to communicate with, for example, memory driver 506 of the computing system 500. The OS 504 may provide runtime services for the memory driver 506 and/or the one or more applications 502. Generally, the OS 504 is a trusted software entity that controls access to peripheral components, such as the memory device 510 via a device driver (e.g., memory driver 506).

A device driver is a computer program that operates or controls a particular type of hardware that is attached (or part of) the computing system 500. In the context of the exemplary memory device 510, the device driver is responsible for operating and/or controlling these devices. In one exemplary implementation, the device driver includes a memory driver 506. The memory driver 506 provides an abstraction layer (e.g., hardware translation layer or HAL) between, for example, one or more memory devices 510 and the application 502 via the OS 504. The illustrated memory driver 506 is trusted; however it is appreciated that some systems may consider the memory driver 506 to be an untrusted application. For example, the memory driver 506 may interface with an external memory device (not shown) via e.g., a network interface or external device interface.

The illustrated driver 506 may be integrated within a memory controller (not shown), or execute on another component, depending on system configuration.

In one exemplary embodiment of the present disclosure, the memory driver 506 provides a memory-mapped input/output (MMIO) interface between the application 502 and the memory device 510. The MMIO is mapped into the same address space as program memory and/or user memory, and is accessed in the same way. MMIO interfaces allow an application 502 to natively access the memory device 510, and manipulate I/O. Unfortunately, MMIO interfaces are fully mapped and decoded for every memory device 510; this can correspond to increased hardware complexity and/or dedicated memory controller logic.

In other embodiments of the present disclosure, the memory driver 506 provides a port-mapped input/output (PMIO) interface between the application 502 and the memory device 510. Port mapped I/O uses a separate, dedicated address space and is accessed via a dedicated set of microprocessor instructions. Less dedicated hardware logic is needed to decode a discrete address for PMIO; however, address translation is performed in software (which is slower relative to MMIO).

Referring back to FIG. 5, an application 502 (which is assumed to be untrusted) may make a request to, for example, dynamically configure a memory array 512 of the memory device 510 through an application programming interface (API). For example, the request through the API by the application 502 may include a request that a predefined size of memory does not need to be refreshed (or should be refreshed according to a prescribed “relaxed” scheme), and/or may/may not require pre- or post-processing.

In some embodiments, the request is checked (e.g., by code associated with the accessed API) to ensure that it complies with the trust protocols of the computer system 500. In other embodiments, the API structurally only accepts requests that comply with trust protocols of the computer system 500. For example, the API may allow the untrusted application 502 to only configure memory that is specifically allocated to itself (the application's isolated resources 502 are also commonly referred to as a “sandbox”).

If the request to dynamically configure the memory array 512 of the memory device 510 is allowed by the trust protocols of the computer system 500, then the request is sent to the memory driver 506. The memory driver 506 may then reconfigure the memory arrays 512 and/or associated logic of the memory device 510 to accommodate the request; e.g., the memory arrays 512 e.g., are not refreshed (or are refreshed according to the prescribed scheme), enables/disables ECC, and/or implements any other operational parameters. In some circumstances, the memory driver 506 may additionally acknowledge to the application 502 and/or the OS 504 that the reconfiguration of the memory device 510 and/or memory arrays 512 has been successful. The memory driver 506 may then service requests from the application 502 in accordance with the successful reconfiguration.

In one embodiment of the present disclosure, the manufacturer of the memory device 510 may specify how to enable reconfiguration of the memory device arrays 512 via various configuration register settings. For example, the manufacturer of the memory device may specify the configuration register settings that enable/disable refresh operations and how to specify the size and/or number of arrays for which the enabling/disabling/reconfiguration of refresh operations applies. The manufacturer may additionally specify other parameters, such as the rate of refresh, and parameters to specify the size and/or number of arrays for which the rate of refresh applies. Various other configuration register settings may be associated with e.g., memory cell configuration and/or pre- or post-processing configurations.

In one exemplary embodiment of the present disclosure, the manufacturer of the computer system 500 may specify the application programming interfaces (APIs) by which an application 502 can access the memory driver 506. In the illustrated embodiment, the API is an interface to the operating system (OS) 504 of the computer system 500, however other variants may incorporate the memory driver 506 as part of a kernel, Basic Input Output System (BIOS), monitor application within middleware, or other privileged software functionality.

Typically, an API will not provide direct access to the configuration register settings provided by the manufacturer of the memory device 510. Instead, the API may identify configurations that are associated with particular properties and/or particular functionality; i.e., at a higher level of abstraction. The manufacturer of the memory device 510 may provide, for example, various bit error rate (BER) options, memory size options, and/or other performance and reliability trade-offs (e.g., between temperature and clock frequency, voltage, etc.). In this manner, an application 502 may identify the appropriate properties and/or functionality to the OS 504; the OS 504 configures the memory driver 506, configuration registers, and/or memory device 510 accordingly.

Consider a scenario where an application 502 requests a substantial amount of memory for an error-tolerant video processing application. The API calls a memory reconfiguration function of the OS 504, which provides the appropriate configuration register settings for the memory device 510 and its memory arrays 512. For instance, the memory driver 506 may reduce a refresh rate for the specified size and/or number of arrays because the video application data is used faster than the default refreshing intervals. Additionally, the OS/memory driver 506 may disable ECC and/or fuse bank operation, relying on the error-tolerant video processing software for error recovery. These and other variations would be readily apparent to one of ordinary skill given the contents of the present disclosure.

In another scenario, the application 502 defines use of a probabilistic refresh scheme (whether explicitly, or indirectly such as via specification of a minimum BER). The OS/memory driver may determine, based on known characterization of the memory device, that a prescribed probabilistic refresh scheme/rate should be applied, and configure the memory controller to operate accordingly. It is noted in passing that a given probability scheme is a “ceiling” of sorts (e.g., higher probabilistic refresh rates can support lower probabilistic refresh rates.). So for example, a memory sector can be configured to utilize a designated “highest” probabilistic refresh rate, and support anything below that rate. Similar logic applies to error tolerance; i.e., a ceiling value specified for allowable error rate such as 1E-17 supports allowable rates of 1E-16, 1 E-15, etc.

It will also be appreciated that uniformity/non-uniformity can be used as a basis for configuring the memory device 510 (and associated controller). For instance, two or more different application programs 502 utilizing uniform and non-uniform functions can aggregate, via the OS/memory driver 506 or controller logic, their respective uniform functions together, and their respective non-uniform functions together.

The foregoing types of operations may be made invisible to the requesting application(s) 502, or alternatively increased levels of transparency may be provided depending on e.g., the sophistication of the requesting application(s) 502 and/or their user, and the desired level of granularity for control.

It is appreciated that a memory device 510 has a finite number of memory arrays 512; for example, a memory device 510 with three (3) distinct memory arrays 512 can only support up to three different memory configurations simultaneously (i.e., one per array 512, on a per-array basis). For instance, two different probabilistic refresh rates cannot be applied to the same array 512 (at least simultaneously), but can be applied across two different arrays. As a result, in some implementations, the OS/memory driver 506 may determine whether or not a given reconfiguration request originated from the application 502 will be granted (or implemented). For example, the memory driver 506 may determine whether a given reconfiguration request can be accommodated in view of the current memory arrays that are currently in use. In some embodiments, if a given reconfiguration request is in conflict with other memory array usage; the memory driver 506 may not implement the reconfiguration request and may notify the OS 504 and/or the application 502 that the request was unsuccessful.

In other embodiments, if a given reconfiguration request is in conflict with other memory array usage, the memory driver 506 may attempt to consolidate different memory array functionality into the least common accepted parameters. For example, an error-tolerant application may share memory arrays with an error-intolerant application; the error-tolerant application is less stringent in its operational parameters and is not adversely affected by higher reliability.

In still other embodiments, the decision of whether or not to implement a given reconfiguration request may be made based on a prioritization scheme. For example, trusted applications may be given a higher level of priority than untrusted applications. In other examples, the OS 504 may prioritize between requests made from a user interface application (which is perceptible to the user) and a request made by a background daemon or other process (which is imperceptible to the user). More generally, the OS 504 may make decisions on reconfiguration requests based on levels of priority for the applications 502 that make the requests. For example, application A may have a higher level of priority than application B. Application B may have a higher level of priority than application C, while application C may have a higher level of priority than application D. Accordingly, OS 504 may implement (or not implement) reconfiguration requests based on this established level of hierarchy. Once the OS 504 has selected the appropriate memory configurations, the OS 504 can instruct the memory driver 506 to configure or re-configure the memory device 510 accordingly.

It is also appreciated that temporal coordination of various parameter implementation decisions may be utilized by the OS/driver 506. For example, where various incompatibilities exist only on an ephemeral or transient basis, or according to a prescribed schedule or rate, the OS/driver may schedule certain probabilistic and/or error-tolerance regimes for implementation on the memory device in accordance with the temporal variation. As a simple example, a first probabilistic refresh rate (e.g., associated with a first application 502) may be specified for period T₀-T₁, while a second rate (associated with a second application) is scheduled for T₁-T₂, and so forth.

Methods of using or operating the aforementioned memory device architecture will now be further described herein.

Methods

Referring now to FIGS. 6A-6I, a logical flow diagram of an exemplary embodiment for a method 600 for operating a memory device with modified refresh (or without refresh) operations in accordance with implemented configurations is shown and described in detail.

First, at operation 601, a timer value is selected for the target memory device based on one or more probabilistic consideration(s). As used in the context of this method discussion, “probabilistic consideration” refers without limitation to considerations relating to a defined probability, a probability or statistical density or other characterizing function, an error rate, or an error tolerance value or function.

In the context of memory devices which may enable/disable refresh operations for one or more of their memory arrays, the timer may be initiated upon the disabling of refresh operations. For example, one or more memory arrays for a memory device may be used with standard refresh operation that is typical for, for example, extant DRAM devices. Upon the disabling of refresh for one or more of these memory arrays, a timer may be initiated. The disabling of refresh may, for example, be initiated by a given application (502, FIG. 5), a given OS (504, FIG. 5), a given memory driver (506, FIG. 5), a memory controller, or combinations of the foregoing. In some implementations in which the memory device (or memory array) does not possess any refresh circuitry, the timer may be initiated upon the receipt of power for the memory device (or memory array).

The duration of the timer may also be varied in some implementations. The memory device (or one or more memory arrays) may be pre-characterized for a given bit-error rate (BER) that may be dependent upon, for example, the size of the memory device (or memory array), the frequency (or rate) of read operations to be performed (see FIG. 1A), the temperature of the memory device (e.g., via temperature sensor 426, FIG. 4; see also FIG. 4A), and/or the underlying physical characteristics (e.g., the physical characteristics of the memory cells themselves) for the memory device.

As one example of the foregoing, the frequency (or rate) of read operations to be performed in combination with the size of the memory device (or memory array) may indicate that every memory cell may be probabilistically refreshed (via read operations), every 60 ms. Accordingly, in such an implementation, the duration of the timer may be set for a relatively long period of time (e.g., every five (5) minutes), or until some other event occurs which would somehow alter the above characteristic, and the memory throughput for the memory device may substantially be improved (e.g., on the order of forty percent (40%)) during that period.

As but another non-limiting example, the temperature of the memory device may be such that (i) a probabilistic refresh rate of approximately every 75 ms, in combination with (ii) the size of the memory device (or memory arrays), and (iii) the frequency (or rate) of read operations to be performed, may enable the duration of the timer to be set at three (3) minutes for a given pre-characterized BER. These and other variants would be readily apparent to one of ordinary skill given the contents of the present disclosure.

At operation 602, a timer for the memory device is initiated. The timer may reside within internal circuitry located on the memory device itself, or in some implementations, may reside external to the memory device and may be transmitted/communicated to the memory device (e.g., via a processor, system memory controller, microcontroller, or other integrated circuit). The timer may be initiated when, for example, the memory contents for the non-volatile memory device are being replaced, and/or when the application that is utilizing the memory device is initiated. For instance, when the memory device is being used in conjunction with proof-of-work (POW) algorithms to process blockchain-based monetary transactions that are recorded in ledgers that are shared or distributed among a community of peers, the timer may be initiated upon the loading of this data into the memory device or memory device array.

In other implementations, the data may be loaded into the memory device where refresh operations are enabled and the timer may be initiated once the data begins to be read (or consumed) and the refresh operations are disabled.

At operation 604 of the method 600, the memory device (or memory arrays) may be operated without refresh operations until it is determined that the timer has expired at operation 606. In other words, so long as the timer hasn't expired at operation 606, the memory device (or memory arrays) may continue to be operated without refresh operations at operation 604.

Once the timer has expired, the memory contents of the memory device (or memory arrays) may be refreshed or replaced at operation 608. For instance, where the memory device contains indigenous refresh capability and that has just been suspended, refresh of the portions of the array subject to the suspended scheme may be refreshed.

Alternatively, where there is no indigenous refresh capability for the portions subject to the timer, the contents of those portions (or the memory array as a whole) may be replaced. In some implementations, the memory contents may be replaced by reading from another one of the memory arrays 512 (FIG. 5) that has been refreshed, located within the memory device 510 that also contains the memory arrays that have not undergone refresh operations. As but another non-limiting example, the memory contents may be replaced by reading from a non-volatile memory device, with the non-volatile memory device either being (i) separate and distinct from the memory device that has not undergone refresh operations; or (ii) a non-volatile memory location residing within the same memory device that has not undergone refresh operations for volatile portions of its memory arrays. As but another non-limiting example, the memory contents may be replaced by reading from another volatile memory device that has enabled (or otherwise utilized) native refresh capabilities, and writing these read contents to the memory device (or memory arrays) that has not undergone refresh operations. These and other variants would be readily apparent to one of ordinary skill given the contents of the present disclosure.

FIG. 6B illustrates another embodiment of the method for operating a memory device according to the disclosure. As shown in FIG. 6B, at operation 612 of the method 610, a modified refresh scheme is selected for use with the memory device based on one or more parameters associated with the memory device. For example, the scheme may be (i) a relaxation of the periodicity of refresh for some or all of the target array, or skipping of refresh for certain portions of the array (a spatially differentiated approach), (ii) adjustment of the refresh (including reduction of rate or skipping) based on one or more globally applicable parameters (a parametrically differentiated approach), (iii) adjustment based on application-specific requirements (an application-differentiated approach), or (iv) a temporally differentiated approach.

Next, at operation 612, one or more refresh values is/are selected for the target memory device based on one or more probabilistic consideration(s) and the selected scheme. As with the method of FIG. 6A, the probabilistic considerations used as a basis for selection of the timer value may include any number of different factors, including those relating to memory array size, temperature, or other physical parameters. However, in the method 610 of FIG. 6B, these considerations are combined with the modification of the refresh scheme so as to achieve the desired probabilistic performance. As one example of the foregoing, the selected modification may be a modification to an extant refresh scheme such as relaxing the refresh rate for a portion of the array (spatial differentiation) which operates at a temperature (a parameter) which is sufficiently lower than another portion of the array. As discussed supra, the operation at a given temperature may be correlated to changes in BER experienced for a given refresh rate (see FIG. 1A). As such, based on a minimum acceptable BER (e.g., as specified via the application 502 of FIG. 5), the refresh rate for the lower BER (temperature) portion may be lowered, or refresh even suspended entirely (akin to the model of FIG. 6A), while other regions operating at higher temperature are maintained at the extant refresh rate or some other rate.

It will also be appreciated that heterogeneous criteria can be applied in selection of the refresh value(s) above. For example, one portion of an array can be refreshed at a given rate to support a probabilistic BER of one value, while another may support the same BER value with a different refresh value. Conversely, different applications 502 may utilize different BER values in determination of the probabilistic refresh values for their respective portions of the array.

Per operation 616, the memory device is operated according to the selected modified refresh scheme and values, and at operation 617, the parameter(s) selected as the basis for the modified scheme (e.g., temperature, time, voltage, etc.) are measured to determine whether the selected modified scheme is still applicable. If so, operation of the device continues, and the method returns to operation 616. If not, the contents of the memory device (or portions thereof subject to the modified refresh scheme based on the monitored parameter(s)) are refreshed per operation 618, and the method returns to operation 612 for selection of a modified (or unmodified) refresh scheme based on the parameter values measured at operation 617. For example, if the lower temperature of the relevant portions of the array in the scenario described above has risen above a prescribed maximum value, then a faster refresh may be dictated.

FIG. 6C illustrates yet another embodiment of the method for operating a memory device according to the disclosure. As shown in FIG. 6C, at operation 622 of the method 620, a desired level of performance for the memory device/array (e.g., based on application 502) is determined. Next, per operation 624, a probabilistic refresh scheme is selected and applied, including an appropriate temporal constraint for the BER of operation 622.

Next, at operation 626, the memory device/array is operated with the selected scheme consistent with (i.e., within) the temporal constraint. During such period, the memory controller tracks non-refreshed cells or regions (e.g., on an individual basis, or on a per-region basis).

At operation 628, when the temporal constraint is reached, it is next determined per operation 630 whether any portions have not been read/refreshed (e.g., by an access to those portions) under the probabilistic scheme, such as where for whatever reason the probability distribution was skewed. If so, then per operation 632, such unrefreshed portions are refreshed, and per operation 634, and the temporal constraint and/or the scheme adjusted accordingly so as to obviate further “active” refreshes of the type used in operation 632 For instance, the refresh interval (using same statistical model) may be shortened, or the probabilistic/statistical distribution model used may be adjusted (e.g., a “white” Gaussian distribution function may have been utilized on the first iteration, when in fact a much more heavily “colored” distribution function may be more applicable to the particular device/array being operated for whatever reason).

FIG. 6D illustrates yet another embodiment of the method for operating a memory device according to the disclosure. As shown in FIG. 6D, at operation 642 of the method 640, a desired level of performance for the memory device/array (e.g., based on application 502) is determined.

Next, per operation 644, an access probability map is determined. Specifically, in one variant, a map of which cells or portions of the array will be accessed at a prescribed frequency based on known or generated statistics associated with the device, controller, and/or application is identified. As a simple example, it may be that a given controller/device combination is programmed to utilize memory accesses associated with one region of the array at 2× the rate of other regions. In more sophisticated implementations, the accesses may be normally distributed across a given address range or physical topology (e.g., most accesses fall within regions of the array that are more proximate to the interface, centrally located within the array, etc., or near the beginning or end of the useable address space). It is noted that this relationship may be “passive” in nature; i.e., by virtue of the extant design, operation, etc. of the underlying devices, or “active;” e.g., where the distribution of accesses is purposely constructed (such as in a NUMA architecture).

Next, at operation 646, a weighted probabilistic refresh scheme is generated based on the map (characterization) of step 644. For instance, in the simple scenario described above (2× rate of accesses for one portion as compared to others), refresh in this 2× portion would occur at 2× that of the other portions (each access causing a refresh), and hence the other portions would require more frequent refresh. It may be that the 2× of the first portion is sufficient to obviate all refresh for that portion (based on target BER), and hence the present disclosure contemplates embodiments where (i) the first (2×) portion is non-refreshed; i.e., refreshed only by accesses, and (ii) the other portions are refreshed after expiration of a timer based in the required BER and statistics applicable to those other portions, such as in FIG. 6A.

Lastly, at operation 648, the device/array is operated according to the generated weighted scheme.

FIG. 6E illustrates yet a further embodiment of the method for operating a memory device according to the disclosure. As shown in FIG. 6E, at operation 652 of the method 650, a desired level of performance for the memory device/array (e.g., based on application 502) is determined.

Next, per operation 654, a parametric probability map is determined. Specifically, in one variant, a map of device or array performance as a function of one or more parameters associated with the device (e.g., temperature, voltage, etc.) is identified. As a simple example, it may be that a given memory device (or portion thereof) may operate differently in terms of BER performance at a first temperature versus a second temperature (see FIG. 3A). In one variant, these characterizations may be determined at a comparatively high level of granularity, such as on a per-portion basis; e.g., a given portion of a memory device may exhibit reduced BER performance relative to other portions which operate at a lower temperature. As a simple example, consider one portion of an array which operates at temperature T=x, and a second (ostensibly identical) portion of the array which operates at T=x+y. If the BER characterization of the first region indicates a given BER of 1E-18 at refresh rate R, and a BER of 1E-17 for the second region at the same rate R, then if the over-arching application 502 using the array requires only 1E-17 BER, then the refresh can be (i) uniformly applied (i.e., all portions refreshed at rate R) across both portions, or (ii) heterogeneously applied or weighted on a per-portion basis; e.g., R for the second portion, and some lesser value (R−z) for the first portion, thereby freeing yet further bandwidth for the device by minimizing the total refresh across both portions.

Next, at operation 656, a weighted probabilistic refresh scheme is generated based on the map (characterization) of step 654. For instance, in the simple scenario described above (differential temperature for one portion as compared to others which produces differential BER performance), refresh in the first portion would occur at lower rate than the other portions. This lower rate can be algorithmically extrapolated (e.g., from the characterizing functions), including by the controller or OS when so configured, and scaled either linearly or according to a step function, such as where a number of preset ranges are specified for temperature, each range corresponding to a given R value that is stored on the memory device or the controller (e.g., as an LUT or other data structure). On-die temperature measurement may be used for instance to provide operational data relating to temperatures of various portions of the array to the above-described controller logic, so that the device may dynamically adapt during operation (e.g., as a function of load, user activity, ambient temperature, etc.).

Lastly, at operation 658, the device/array is operated according to the generated weighted scheme.

FIG. 6F illustrates yet a further embodiment of the method for operating a memory device according to the disclosure.

As shown in FIG. 6F, at operation 662 of the method 660, a desired level of performance for the memory device/array (e.g., based on application 502) is determined.

Next, per operation 664, a probabilistic refresh scheme is selected and applied, including an appropriate temporal constraint for the BER of operation 662.

Next, per operation 666, operations whose completion would exceed the identified temporal constraint from operation 664 are identified. For instance, if a given process within an application requires several memory accesses to complete, and these accesses span (and exceed) the temporal constraint, then refresh for those portions of the array accessed by the process can be obviated (since the sequence of reads/writes will in effect refresh those portions of the array), and refresh according to the probabilistic scheme applied only to the remaining (non-identifier) portions per operation 668.

Per operation 669, the identified operations can further optionally be offloaded to software, such as e.g., software processes outside of or separate from the controller.

FIG. 6G illustrates yet a further embodiment of the method for operating a memory device according to the disclosure. As shown in FIG. 6G, at operation 671 of the method 670, a desired level of performance for the memory device/array (e.g., based on application 502) is determined.

Next, per operation 672, a probabilistic refresh scheme is selected and applied, including an appropriate temporal constraint for the BER of operation 671.

Next, per operation 673, the required ECC associated with the given scheme is determined. For instance, if a BER of 1 E-17 is selected by the application 502, and the memory device/array characterization for the desired application indicates that this BER is achievable using a Gaussian “white” distribution model at a prescribed refresh rate R, then there is low probability that statistical variation will result in errors outside the acceptable maximum level (here, 1 E-17), due to e.g., low probability of a solar-induced or neutron-induced “bit flip” or so-called “row hammer” under normal expected circumstances of operation. Moreover, in cases where the end application is error-tolerant, the need for ECC is obviated (or at least reduced).

Accordingly, per operation 674, where ECC can be turned off, the ECC is turned off by the controller, and the memory operated without ECC. The ECC bits can be repurposed as previously described (operation 675), such as by using their additional bits for expanded memory addressing range, counters for statistical or other processes, flags, etc.

Conversely, where ECC cannot be turned off, the memory array/device is operated in accordance with the selected probabilistic scheme (consistent with the temporal constraint), with only the required level of ECC applied per operation 676.

FIG. 6H illustrates yet a further embodiment of the method for operating a memory device according to the disclosure. As shown in FIG. 6H, at operation 681 of the method 680, a desired level of performance for the memory device/array (e.g., based on application 502) is determined.

Next, per operation 682, a probabilistic refresh scheme is selected and applied, including an appropriate temporal constraint for the BER of operation 681.

Next, per operation 683, a plurality of pending memory accesses are evaluated for possible parallelism. As used in the present context, the term “pending” refers to then-pending, or anticipated to be pending at some future time (e.g., scheduled by a scheduler of the OS or memory controller during a prescribed period of time). For instance, it may be that a given process or thread block of an application 502 being executed by the host device CPU (or a particular core thereof) has N constituent operations or individual threads; depending on thread execution and interdependency (e.g., one thread locks or is “barriered” until results of another thread are complete), such thread block, including a plurality of memory accesses associated therewith, may take much more than the allocated temporal constraint to complete, especially if executed in a serialized fashion on the same core. If each constituent operation scheduled by the e.g.. kernel/CPU scheduler is performed in a parallel (or at least partly parallel) fashion, consistent with its interlocks/barriers, and the memory accesses associated with these processes are distributed across multiple cores, then depending on the level of parallelism and the ability to perform the memory accesses within the temporal constraint for each different “probabilistic” memory array in the device, then refresh can be obviated for at least some of the arrays (or portions thereof). Conceptually, this can be thought of as taking a comparatively long series of events which includes a number of individual memory accesses, which if performed serially by e.g., a single core would result in at least several mandatory refreshes of the memory array in use because the accesses would be spread out in time and would occur in somewhat unpredictable fashion (especially where one access was interlocked to another's completion), and selectively dividing the long series of events up into a number of smaller pieces (the division based on e.g., memory accesses), and allocating the pieces to different cores/memory arrays (or portions of arrays) such that each memory access can act as a refresh event for its respective array/portion, thereby obviating refresh and its associated bandwidth loss.

Returning to FIG. 6H, if no parallelization is possible, then per operation 685 the memory device is operated “serially,” i.e., as a probabilistic-refresh based device with the applicable temporal constraint(s) applied.

Conversely, if parallelization is possible per operation 684, then per operation 686, access (N) and core (A) counters are set (processor cores and threads typically utilize “0” as starting point for enumeration), and per operation 687, a first (N=0) access allocated to Core 0 for execution. Next, per operation 688, the access counter N is incremented, and the status of the next access relative to a common thread (each of which can be assigned to a different core for execution) is determined per operation 689. For instance, a thread block may contain 32 threads, which may be interlocked or related to other threads in the same thread block. In one approach, thread commonality is used as the basis for determining whether a given memory access is allocated to same or different core (operation 690), although other metrics may be used; e.g., same thread block, warp, etc.

FIG. 6I illustrates yet another embodiment of the method for operating a memory device according to the disclosure. As shown in FIG. 6I, at operation 692 of the method 691, a desired level of performance for the memory device/array (e.g., based on application 502) is determined.

Next, per operation 693, a probabilistic refresh scheme is selected and applied, including an appropriate temporal constraint for the BER of operation 692.

Next, per operation 694, a utilization metric (e.g., fraction) for the memory controller is determined. For example, the memory controller may be, over a prescribed period of time (on average) under-utilized in terms of its bandwidth capability; i.e., it can perform more accesses per unit time that it is currently performing. This may result from, e.g., limitations associated with the requesting application 502. As such, this “wasted” controller capacity can be used productively in certain embodiments of the disclosure, including for purposes of probabilistic refresh.

In one example, per operation 695 when the utilization fraction indicates less than complete utilization, an “overfetch” scheme is determined, and relevant parameters relating thereto calculated by either the OS or the controller (depending on configuration). For instance, if the bandwidth utilization of the controller and associated interface is only say 50%, then the remaining 50% can be used for overfetch, and the controller can schedule such overfetches either as part of extant access requests (e.g., by modifying an access request for greater scope or address range), or creation of new “dummy” requests or accesses, so as to consume the remaining portion of the available bandwidth of the controller. In one variant, the overfetched data is merely discarded by the controller; by this point, it has accomplished its purpose; i.e., refreshing portions of the array (via reads) which would not have otherwise been refreshed at least during that access using an unmodified request.

Per operation 697, the calculated overfetch of operation 695 is evaluated to determine whether the requisite probabilistic refresh scheme is “satisfied” by the overfetch. Two scenarios arise in this exemplary embodiment: (i) the overfetch will obviate the need for refresh altogether (i.e., the additional controller bandwidth in conjunction with the requested accesses themselves will, statistically speaking, rewrite all of the cells/portions of the array within the prescribed temporal constraint associated with the target BER) as in operation 698; or (ii) the overfetch will not completely obviate refresh, but reduce it (as in operation 699).

Notably, at operation 694 and its subsequent determination, if the controller bandwidth has been completely utilized, then the method will proceed to operation 696, wherein the probabilistic scheme is applied with the temporal constraint, with the refresh rate being higher than that associated with scenario (ii) above (i.e., partial reduction).

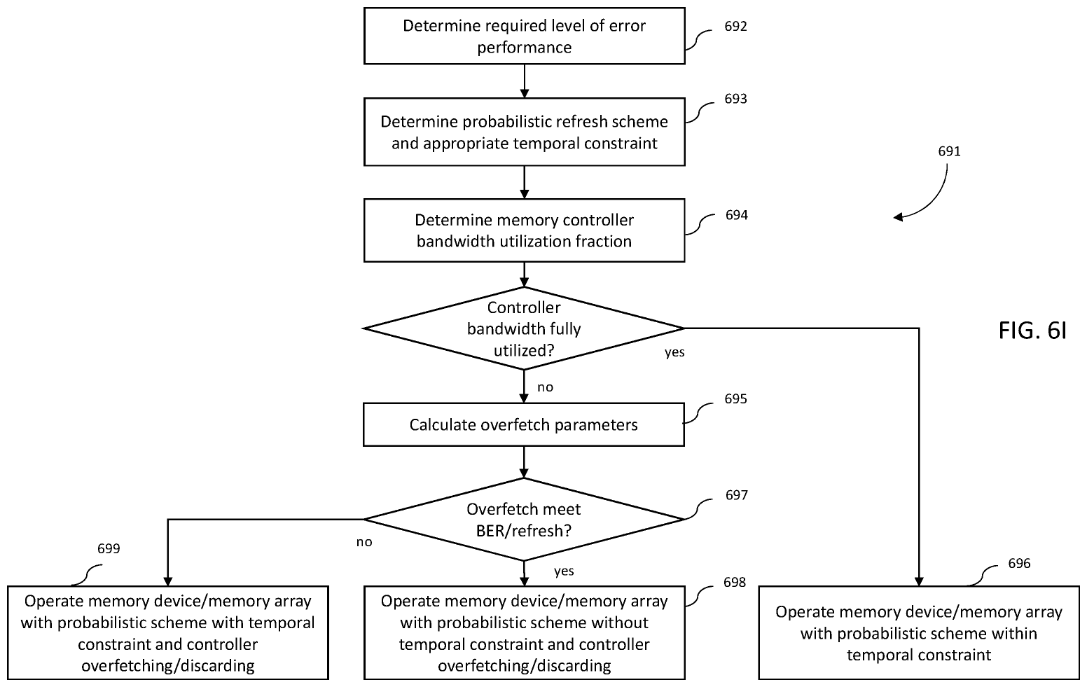

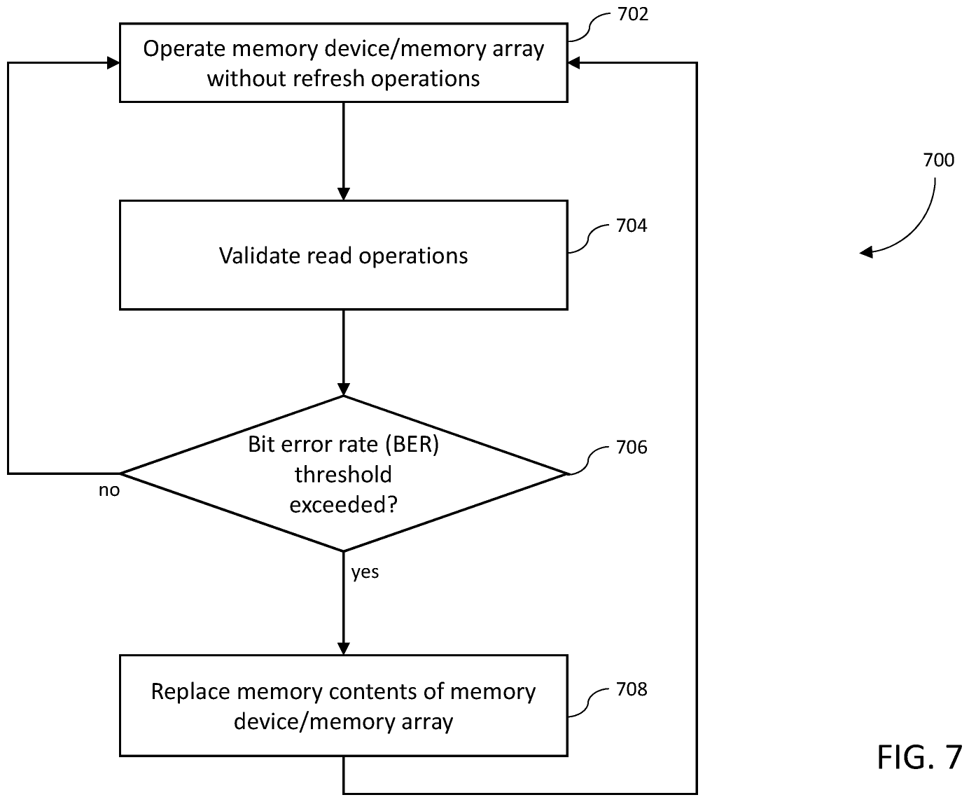

Referring now to FIG. 7, a logical flow diagram of another exemplary generalized method 700 for operating a memory device with validation in accordance with implemented configurations is shown and described in detail.

At operation 702, the memory device (or memory arrays) may be operated without refresh operations. For example, the memory device (or memory arrays) may disable previously enabled refresh operations and may be operated without refresh. In some implementations, the memory device (or memory arrays) may not include refresh circuitry, and hence may be operated without refresh only. For example, one or more memory arrays of a memory device may not include refresh circuitry, while one or more other memory arrays may include refresh circuitry.

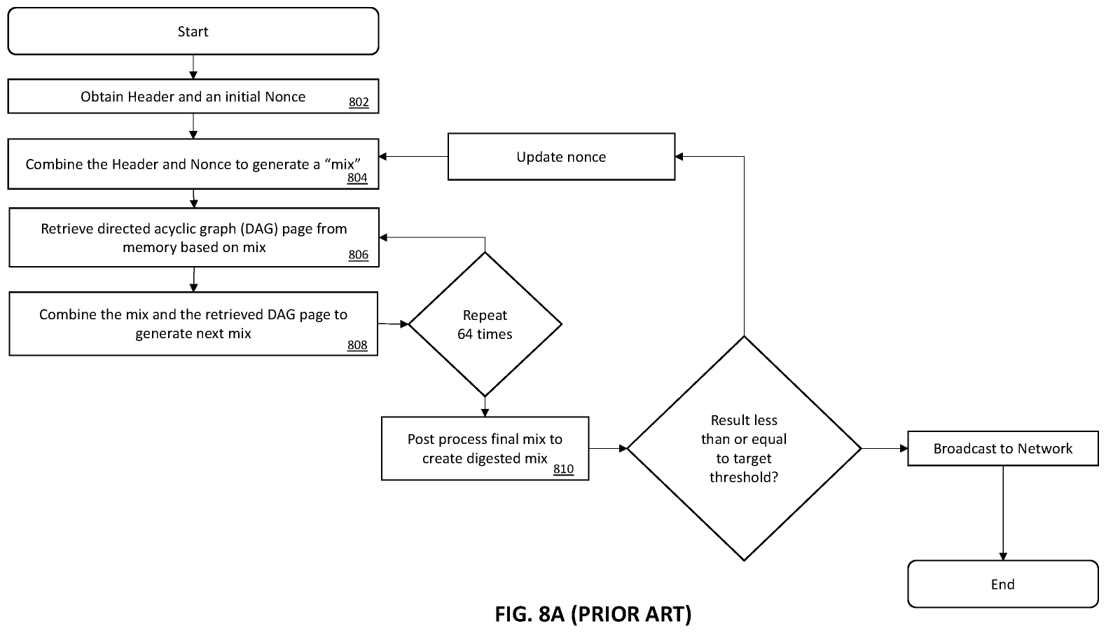

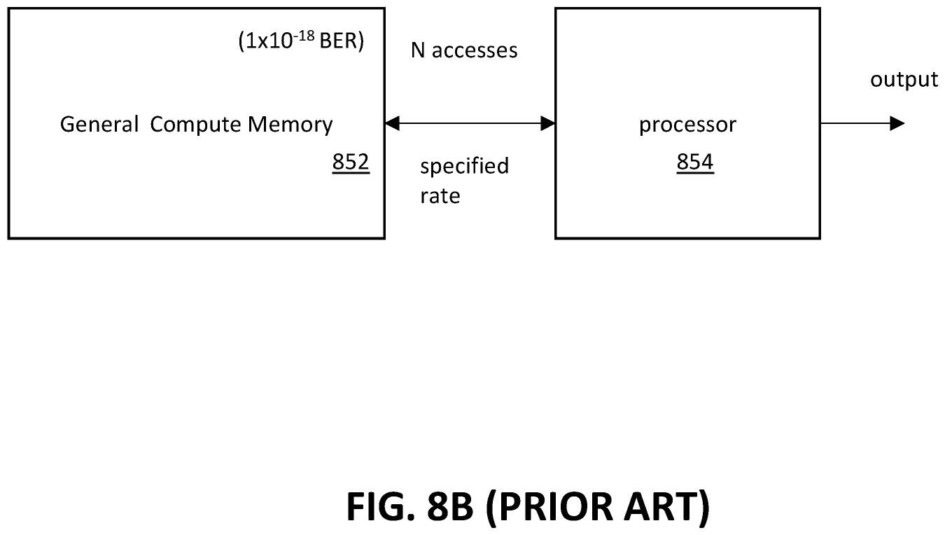

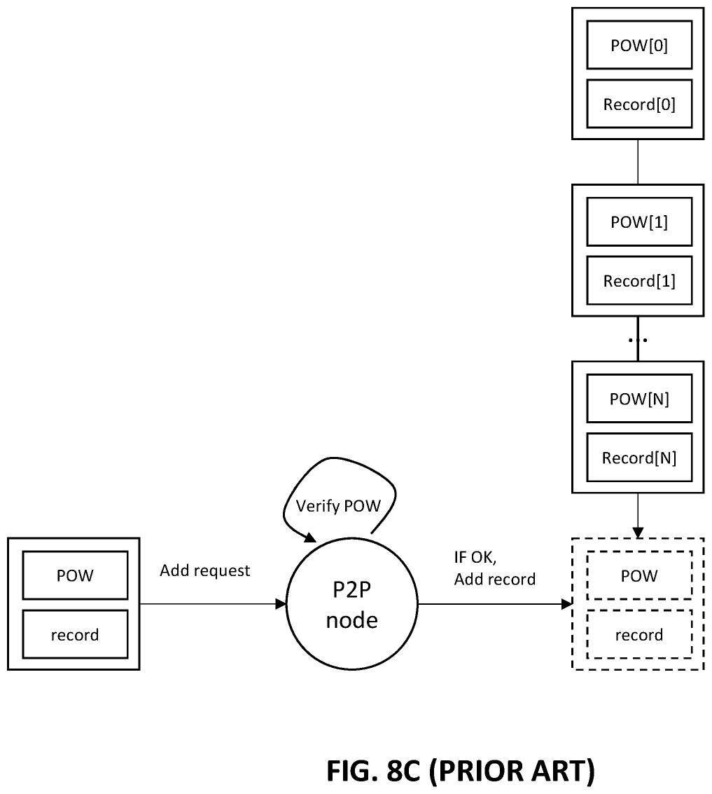

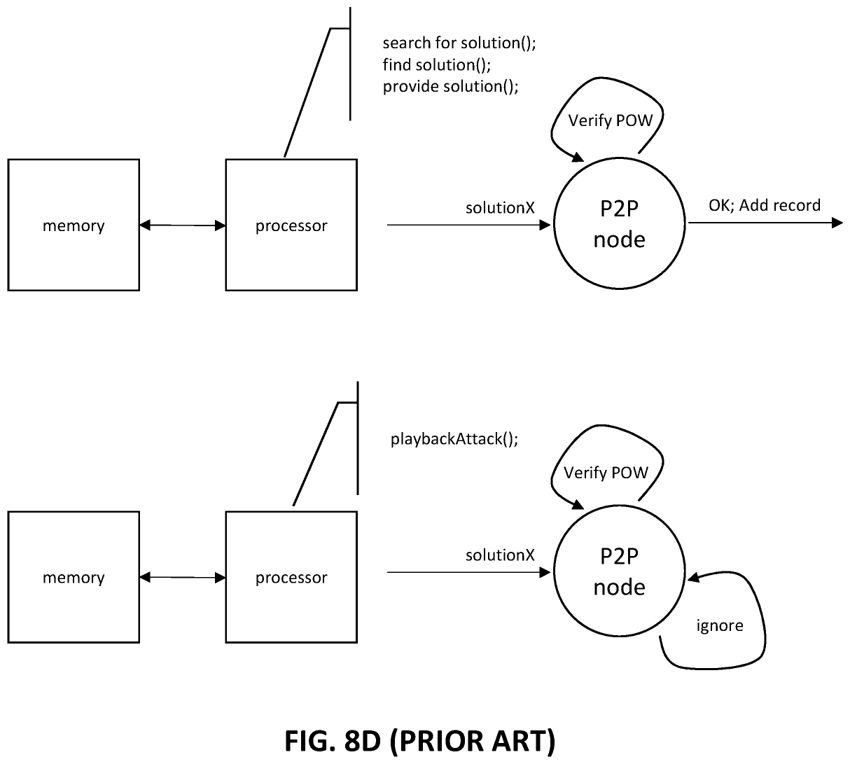

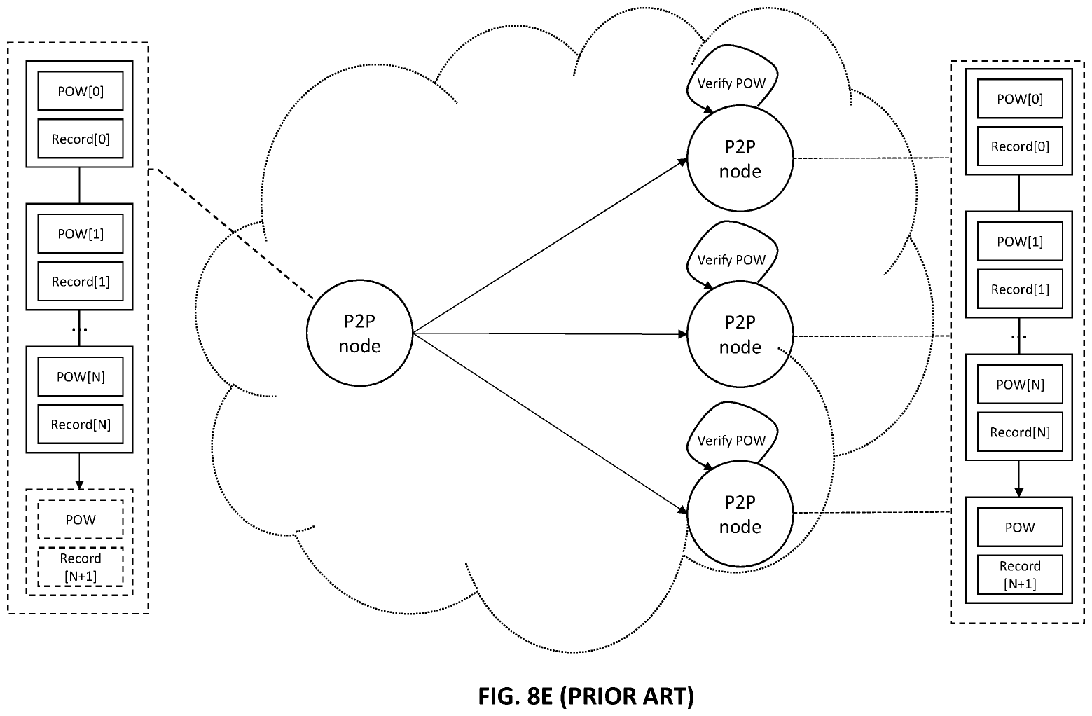

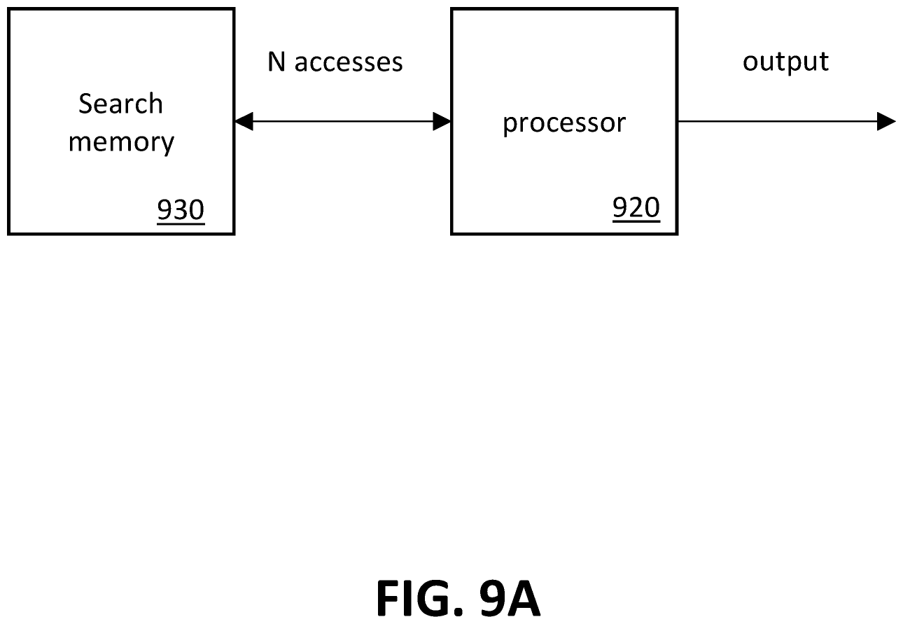

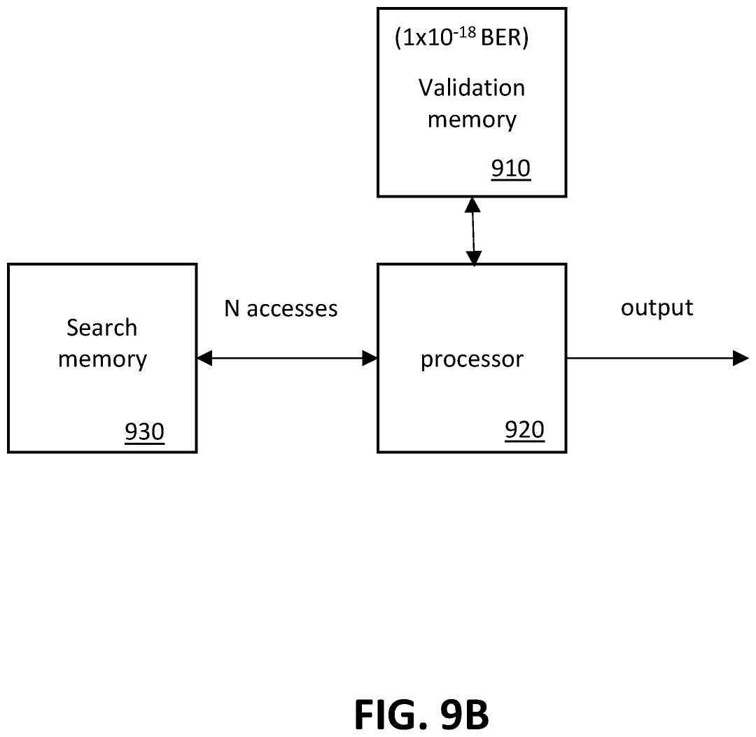

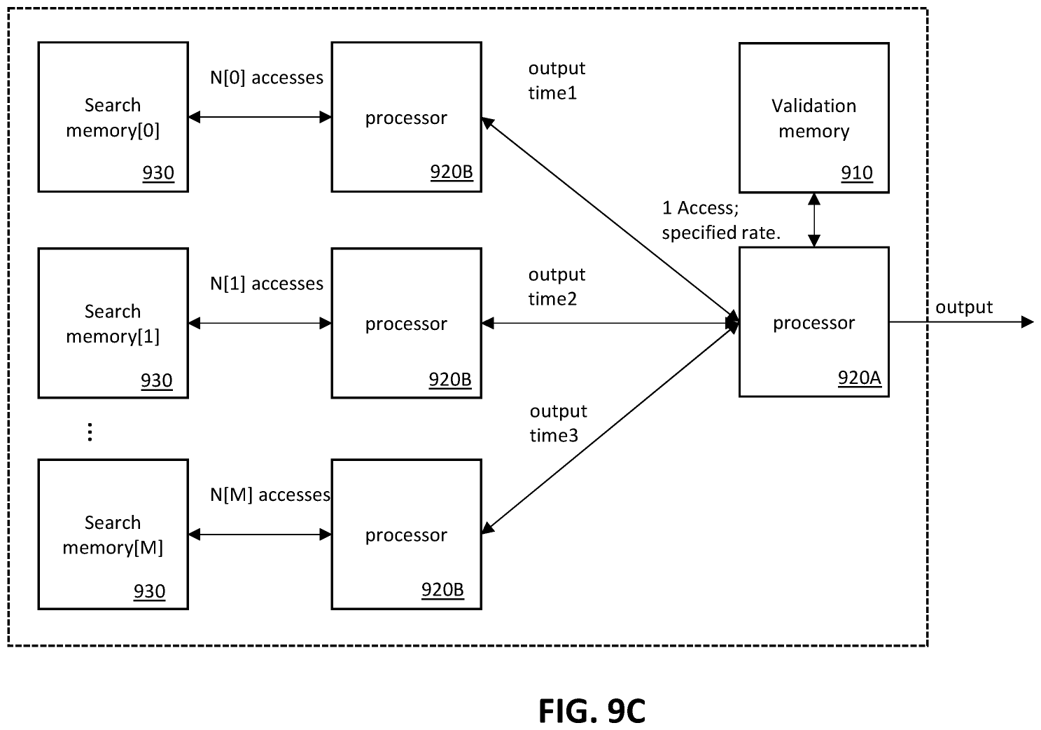

At operation 704, read operations that are read from the memory device (or memory arrays) may be validated with another memory device (or another memory array) or via other mechanism such as ECC. For example, the memory device may include two memory arrays, with one of these memory arrays having refresh circuitry enabled and the other one of these memory arrays having the refresh circuitry disabled. The data that is loaded into one of the memory arrays may be identical to the data that is loaded into the other one of the memory arrays. Accordingly, the data being read from the memory array without the refresh circuitry enabled may be validated against the memory array with the refresh circuitry enabled. See also, for example, the first example operation discussed with references to FIGS. 8A-9C described infra.

As a result of validation at operation 704, the BER associated with the memory array with the refresh circuitry disabled can be determined and utilized at operation 706. As but another non-limiting example, one memory device (or portions thereof) may be loaded with data; while another memory device (or portions thereof) may be loaded with identical data. Accordingly, the data being read from the memory device without the refresh circuitry enabled may be validated against the other memory device with the refresh circuitry enabled. As a result of validation at operation 704, the BER associated with the memory device with the refresh circuitry disabled (or otherwise not enabled) can be determined and utilized at operation 706. These and other variants would be readily apparent to one of ordinary skill given the contents of the present disclosure.

At operation 706, a BER threshold may be established or otherwise set if not already done so (e.g., by the application 502), and the data being read from the memory device may be used to generate a BER value, the value which is compared against the BER threshold. For example, a first error-tolerant application may only require a BER of 1 E-14, while a second error-tolerant application may require a BER of 1 E-15. Accordingly, while executing the first error-tolerant application, the memory device (or memory arrays) may be operated without refresh operations until the BER exceeds the established threshold. Moreover, while executing the second error-tolerant application, the memory device (or memory arrays) may be operated without refresh operations until the BER exceeds the relevant established threshold of 1E-15. Other BER thresholds may be readily established dependent upon, for example, the desired application with the foregoing examples merely being exemplary.

At operation 708, and once the BER exceeds the previously established BER threshold, a write operation may be performed on the memory device in order to replace the contents previously contained in memory. For example, the memory contents may be read from another memory device and written to the memory device that operates without refresh operations. In some implementations, the memory contents may be read from another memory array (with refresh enabled) and written to the memory array that operates without refresh operations.

### Example Use Cases

Exemplary use cases and modes of operating the aforementioned memory device architecture will now be further described herein.

Ethash Cryptocurrency Mining

One exemplary usage scenario that can take advantage of the aforementioned memory device architectures is blockchain-based cryptocurrency type applications, and in particular, its use for proof-of-work (POW) mining applications. For example, Ethereum is one exemplary blockchain-based distributed computing platform and operating system. As a brief aside, Ethereum networks create and transact Ether as a cryptocurrency. FIG. 8A is a logical flow diagram of an existing method for POW mining with the Ethash algorithm in the context of Ethereum.

At operation 802, the miner generates a short binary blob (binary large object) “nonce”; a nonce is data that is only used once (e.g., to avoid playback type attacks). Within the context of Ethash, the nonce serves as an input to a mixing process and algorithm. The miner combines the nonce with unique header metadata (including timestamp and software version) derived from the latest block of the blockchain. A SHA3-like (Secure Hash Algorithm 3) algorithm is used to combine the pre-process header and nonce to create an initial 128 byte “mix” (operation 804).

At operation 806, the 128 byte mix is used to identify a 128 byte page to retrieve from memory based on an Ethash specific directed acyclic graph (DAG). As a brief aside, a DAG provides a pseudorandom memory data set that is computationally straightforward to generate. The DAG dataset is generated as a linear function of the blockchain length, and is regenerated every 30,000 blocks (a so-called “epoch”). As of the present disclosure, the DAG was approximately 4 GB, and the DAG will continue grow in size as the blockchain grows. Retrieving memory pages from the DAG stored in memory is physically constrained by memory bandwidth; thus, the periodically changing Ethereum DAG provides a source of memory hardness for Ethereum.

Referring back to FIG. 8A, once the 128 byte page is retrieved from the DAG, it is combined with the initial 128 byte mix, yielding a new mix (operation 808). The new mix is then utilized to identify another DAG page to retrieve. Once that new DAG page is retrieved, it is combined with the new mix to generate yet another mix. This process is performed 64 times. After the 64^{th} time of mixing, the resulting 128 byte mix is then post-processed to generate a shorter, 32 byte digested mix (operation 810).

After the mixing function and post-processing, the 32 byte digested mix is compared against a predefined 32 byte target threshold. If the 32 byte digested mix is less than or equal to predefined 32 byte target threshold, then the current nonce is considered valid, and can be broadcast with the header as a POW to the Ethereum network. If the target threshold is not met, the current nonce is considered invalid, and the algorithm is re-run with a different nonce (either by incrementing the current nonce, or picking a new one at random).

While not expressly shown in FIG. 8A, it should be emphasized that searching for a nonce and header combination that will result in a digested mix that satisfies the target threshold may require many attempts; in other words, searching for a valid nonce requires a substantial amount of physical entropy in the form of memory bandwidth. However, once a nonce is successfully found, any peer entity can straightforwardly verify that the nonce indeed results in a value that satisfies the target threshold, by checking that the header/nonce combination and DAG lookups to generate the digested mix. Moreover, since each header and nonce combination can only be used once, the Ethash algorithm ensures that only new nonce searches can be added to the blockchain.

FIG. 8B is a logical block diagram of an existing apparatus configured to search for proof-of-work (POW) with the aforementioned Ethash algorithm of FIG. 8A. As shown in FIG. 8B, the system includes a general compute memory 852 and a processor 854. The general compute memory 852 is “specified” for an identified performance under standardized conditions (e.g., a 3.6 Gb/s GDDR RAM provides 3.6 Gb/s at 1×10⁻¹⁸ BER, at a particular voltage, temperature, humidity, etc.). The general compute memory 852 stores the Ethash specific directed acyclic graph (DAG) and each iteration of the Ethash algorithm requires 64 accesses to generate a digested mix. Since the vast majority of header/nonce combinations will not satisfy the target threshold, the apparatus is likely to consume a significant amount of memory bandwidth for each attempt.

FIG. 8C illustrates the process by which proof-of-work (POW) that is generated by an Ethereum miner can be used in the context of the blockchain-based shared ledger.

Each transactional block includes data representing each transaction (e.g., a POW and record). The record typically includes unique header metadata (including timestamp and software version) derived from the latest block.

A proposed transaction (including a generated POW and a record) is broadcast to the network and validated by peers; for clarity, only a single P2P peer is shown in FIG. 8C. Specifically, the P2P peer receives a block that is proposed to be added to the blockchain. If the POW is successfully verified by the P2P peer node, then the proposed block can be added to the blockchain. In some cases, the miner may also receive a reward in the form of the digital currency (e.g., Ether).

As previously alluded to, cryptocurrency mining is designed to account for malicious parties and fake POW. Transactions added erroneously or maliciously will not be verified by other miners in the network and will not persist in the blockchain. Furthermore, the Ethereum network penalizes malicious behavior. Specifically, the node or IP address associated with a misbehaving miner can experience undesirable consequences, like being banned or temporarily kicked from the network.

For example, as shown in FIG. 8D, a solution (header/nonce combination) can only be used once. If the same solution is repeated (e.g., in a playback type attack), then the P2P node will reject the new solution. Since the DAG is shared by all of the Ethereum miners and the DAG is regenerated at 30,000 blocks, there are 30,000 unique solutions that the miners of the Ethereum mining community are in a race to find. More directly, a miners' profitability depends on their ability to generate valid header/nonce combinations and the amount of computing power they devote to the process in outputting valid blocks before other miners.

Furthermore, the shared ledger nature of the Ethereum blockchain also ensures that each of the peer mining nodes of the Ethereum community cannot falsify a record. As shown in FIG. 8E, when a peer node successfully adds another block to the blockchain, the proposed blockchain is provided to each of the other peer nodes. Only when a majority of the peer nodes of the community have reached consensus that the proposed addition is legitimate does the proposed ledger become the shared ledger. If the peer network does not reach consensus, then the proposed ledger is ignored. When the shared ledger successfully adds another block, then the miners will stop work on the current block and start on the next block.

As a related corollary, the fact that a blockchain accumulates entropy means that the rate at which entropy is being added to a community is a “proof of cooperation” without any central organizer. Specifically, one computer is only capable of adding a certain amount of entropy, but a million computers working together generate entropy additively (a Poisson process). In other words, the largest pool of entropy is considered the valid state of the network (the consensus of the community), and the largest pool of entropy can only be generated by the network as a whole; it cannot be generated by a single attacker or even a subset of the pool. Thus, the ability to measure consensus or cooperation is as simple as validating the amount of entropy of the system.

More generally, artisans of ordinary skill in the related arts will appreciate that cryptocurrencies (like Ethereum) that are based on a community of untrusted parties which cooperate to share a public ledger must implement barriers to malicious activity and/or penalize malicious behaviors. The combined results of infeasibility of attack, expense to attack, and the likelihood of penalty for a failed attack provide strong disincentive for malicious behavior within cryptocurrency networks; in this manner, cryptocurrency networks are able to ensure that the shared ledger can be trusted, without vesting trust in any single party.

One inference that can be made in view of Ethereum POW mining is that the solution density is very “sparse.” As used in the present context, the term “sparse” refers to a solution space that is in general very thinly populated with solutions. In other words, the vast number of attempted header/nonce combinations are not valid solutions; in fact, the sparsity of the Ethash algorithm is an intentional property of proof-of-work algorithms. More directly, as specifically noted above, the probability that a valid solution is miscalculated and passes due to luck is insignificant. However, in a related corollary, the probability that an invalid solution is miscalculated and believed to be valid (i.e., a false positive) may be more common, however sufficiently rare as to offset other considerations (such as cost or speed).

Hence in sum, conventional wisdom has held that mining with unreliable memory is not desirable, as it will likely result in broadcasting invalid POW solutions, thereby wasting resources (e.g., time and power), and perhaps being banned from the network. However, the foregoing analysis shows that some level of invalid POW may be tolerable and/or even preferable.

### First Example Operation, Search Memory without Refresh

FIG. 9A illustrates one exemplary embodiment of a first memory architecture according to the present disclosure. As shown in FIG. 9A, the exemplary apparatus is configured to search for POW with the aforementioned Ethash algorithm in a manner that does not reject invalid solutions. The system includes a volatile memory device 930 that does not include refresh circuitry (or otherwise implements reduced or alternate mechanisms for refresh as described above) in order to refresh the contents stored therein as well a processor 920. In the context of searches for POW, the memory device may be thought of as “search” memory 930 and may include an Ethash specific directed acyclic graph (DAG).

As the memory device 930 does not include, or otherwise less frequently utilizes, refresh circuitry (or alternate refresh mechanism), the memory device may be less reliable than so-called general compute memories dependent upon how the memory device 930 is utilized. For example, if the entire search space of the memory device 930 is not accessed (i.e., read) or otherwise refreshed at a sufficient frequency, the memory contents will eventually become corrupted as the data stored within individual memory cells eventually will dissipate. However, if the entire search space of the memory device 930 is sufficiently refreshed (e.g., via a specified rate of access/refresh), the memory device 930 may be “probabilistically refreshed” with reduced or even completely obviated dedicated refresh operations. As discussed elsewhere herein, utilizing the memory device 930 without (or with reduced) refresh may significantly improve the internal bandwidth (e.g., by approximately 40%) as compared with a comparable memory device that does utilize refresh circuitry on a consistent basis (i.e., so-called general compute memory devices). However, as it is not guaranteed that every memory cell will be sufficiently refreshed under the probabilistic approach, use of the memory device 930 may be expected to introduce some level of errors.

In other words, using the memory device 930 for mining consistent with the present disclosure will intentionally tradeoff errors for other benefits e.g., improved performance, reduced cost, etc. For example, if 3% of results are invalid but the results are being generated 25% faster, the overall acceleration of the system is ˜21.25% (e.g., 125% faster times 97% accuracy). The overall boost may be even greater in “race” scenarios such as cryptocurrency mining (i.e., only the first miner to locate a solution is rewarded, the second miner loses out even if he/she eventually locates the same solution).

Eventually, the memory device 930 may become corrupted so that its contents may no longer be useful for the intended application. At that point the memory device 930 will need to have its contents reloaded (e.g., through the use of another memory device). Although the re-population of the memory device 930 is relatively time-consuming, the performance advantages associated with obviating deterministic refresh cycles may far outweigh the relatively costly re-population of the memory device.

As another example, an AI (artificial Intelligence) application may desire to focus on a particular subset of solutions (e.g., a memory space). Unlike the Ethereum scenario described above (where the search is considered largely uniform; i.e., each result is considered to return a potentially valid result), some AI applications may wish to utilize non-uniformity in the conduct of the search. This non-uniformity can be accomplished in a number of different ways, including for example and without limitation: (i) limitation of the search area, or (ii) weighting of results in a particular search area more heavily (over other solutions). As such, since the results of e.g., a weighted search are non-uniform, so may be their associated refresh scheme(s).

Consider for instance the use of such AI algorithms in the application of image recognition on a self-driving vehicle (e.g., car, bus, truck, etc.). Certain portions of time during the operation of this AI system are highly critical (e.g., immediately before and during a lane change). During a highway (high speed) lane change operation where the lane change happens quickly and/or there is a high density of other vehicles, the image recognition search space may be coded to turn off refresh to increase memory controller bandwidth (relying instead that the media bandwidth will provide sufficient probabilistic refresh by repeatedly and frequently searching over the same memory space in support of the AI recognition algorithms). In contrast, during a country road lane change or other comparatively slow speed event, the event may happen too slowly to allow for probabilistic refresh. Under these circumstances, the refresh is maintained (the slower memory access is acceptable because the event is slow relative to the nominal AI processing speed).

As yet another example, a 3GPP 5G NR (New Radio) system may require high-speed operation of memory devices associated with various components (e.g., a gNobe B or gNB) within e.g., a network “slice” dedicated to a certain type or class of communication. Such systems are intended to obey very strict latency requirements (e.g., 1 ms round trip), and as such, conventional infrastructure may be incapable of providing such low latency, especially within a QoS or “guaranteed” application environment. Such low latency enables a plethora of potential technologies, including cloud-based AI and machine learning, cloud-based VR/AR, etc. As such, the inventive memory devices and methods of the present disclosure may be applied in support of such requirements.

For instance, in one scenario, probabilistic memory is used to reduce or eliminate refresh requirements and accordingly increase memory bandwidth (and hence reduce latency imposed by the memory device in servicing 5G NR related operations executed by the host processor). In one such case, the refresh is temporarily turned off based on probabilistic analysis that a sufficient BER performance will be maintained during that period. In another case, the accesses needed to support the 5G NR operations are scheduled for only prescribed regions of the memory device, such that the prescribed regions can operate without refresh (whether for a period of time or indefinitely) due to the frequency of memory accesses used to support the low-latency 5G NR operations, thereby increasing memory device bandwidth a reducing latency.

Artisans of ordinary skill in the related arts given the contents of the present disclosure will readily appreciate that the foregoing examples are purely illustrative; various considerations may be considered in determining acceptability of operation. For example, the acceptable error rate may be based on the amount of penalty imposed by the network; shorter temporary bans may result in a higher acceptable BER, longer or even permanent bans may require much lower BER.

### Second Example Operation, Use of Validation Memory

As discussed supra, volatile memory devices that do not use refresh circuitry can be directly used in Ethereum POW mining. However, as previously alluded to, broadcasting invalid solutions directly to the network from a memory device could have undesirable consequences or invoke countermeasures (e.g., the submitter could be banned temporarily or permanently from the network, or at a minimum, waste resources on generating and broadcasting false POW solutions that will not result in any rewards). Accordingly, as shown in FIG. 9B, the present disclosure also envisions a mechanism to validate POW solutions before they are broadcast, such that memory device 930 utilized as search memory can be used without the risk of suffering undesirable consequences.

FIG. 9B depicts one exemplary embodiment of a second memory architecture according to the present disclosure. As shown in FIG. 9B, the memory architecture comprises a search memory 930 and processor apparatus 920 that includes, or has access to, a validation memory 910. During operation, the second memory architecture uses the search memory 930 to search for, and generate, POW solutions in accordance with the aforementioned processes; thereafter the validation memory 910 is used to validate the generated POW solutions. For example, the processor 920 can execute a hash algorithm utilizing the search memory 930 to find a POW solution and then execute a one-time look up verification of the POW solution utilizing a general compute memory at its specified rate (e.g., 1E-18 BER).

As previously alluded to, Ethash is asymmetric in that a solution is difficult to find, but very easy to verify. Within the context of FIG. 9B, the validation memory 910 can be used to verify the POW identified by the search memory 930 with low processor utilization and a relatively small amount of memory. For example, anecdotal data shows that the Ethash POW mining takes approximately 12-15 seconds to find a suitable header/nonce solution, whereas validation can occur almost instantaneously.

In one exemplary embodiment, the search memory 930 is operated to maximize overall search speed (even at the expense of accuracy) by not using, or otherwise disabling, refresh circuitry, whereas the validation memory 910 is used to accurately verify the search (which does not need to be done quickly). A variety of techniques can be used to maximize the search speed and/or minimize costs of the search memory 930. For example, eliminating refresh on the search memory 930 improves upon the internal bandwidth for memory accesses within this search memory 930. Once a predetermined number of errors, and/or a pre-determined BER, are detected by the validation memory 910, the entire contents of the search memory 930 may subsequently be reloaded. For example, software executed by the processor 920 may initiate a read from the validation memory 910 and a write to the search memory 930. In some variants, rewriting the search memory 930 merely entails an entry-by-entry copy of the validation memory 910. In other words, the validation memory 910 has the “clean” copy of the Ethereum DAG. The DAG need not necessarily be regenerated from scratch for the search memory 930.

In some implementations, the validation memory 910 can use a very slow memory that has good BER. In other variants, the validation memory 910 can use memory technologies that are optimized for other applications. For example, a DRAM (which is volatile) can be used to quickly and inexpensively mine for POW, whereas a flash memory (which is non-volatile) can be used as a low-power validation memory. In some implementations, the search memory 930 and the validation memory 910 can be co-located such that they both reside within the physical space. For example, the search memory 930 and the validation memory 910 may reside within a partitioned memory device such as that described in co-owned and co-pending U.S. patent application Ser. No. 16/505,472 filed Jul. 8, 2019 and entitled “Methods and Apparatus for Dynamically Adjusting Performance of Partitioned Memory”, the contents of which are incorporated herein by reference in its entirety. In other words, one partition (e.g., one or more memory arrays) may have refresh circuitry disabled and hence, may act as the search memory 930; while another partition may have refresh circuitry enabled and hence, may act as the validation memory 910.

Additionally, the memory architecture of FIG. 9B provides additional synergies which may be unavailable to e.g., the simpler memory architectures. In one exemplary embodiment of the present disclosure, the validation memory 910 tracks the error rate of the search memory 930 and monitors memory performance in view of an expected solution density function. For example, within the context of Ethereum POW mining, the validation memory 910 can determine how well the search memory 930 is performing over time. More directly, if the rate for the search memory 930 is expected to yield a solution density of 90% (e.g., a BER of 1 E-05), but the actual solution density is closer to 70%, then the memory is underperforming (e.g., roughly equivalent to a BER of ˜5E-05).

In some variants, the underperforming search memory may be re-configured for a lower performance. For example, by reducing clock frequency, the memory performance may return to acceptable levels. In other cases, the search memory 930 may still offer sufficient solution density to continue operation in its degraded state. In still other implementations, the processor 920 may initiate corrective action (such as more frequent refreshes, or a rewrite of the DAG entries).

As a brief aside, DRAM memory technology stores information as a charge in a capacitive cell; over time, the charge in the DRAM cell decays, thus the DRAM cell must periodically be “refreshed” with the proper value. In some cases, a cell may have a “soft error” because the charge has decayed to the improper value; soft errors may be a product of manufacture (e.g., manufacturing tolerances may result in slightly more or less capacitance for each cell), probabilistically occur over time, and/or may even be intentionally allowed to accumulate. For example, refresh consumes memory bandwidth (the cell cannot be accessed during refresh) thus refreshing may be reduced to increase memory bandwidth. In contrast, malfunctioning cells are considered “hard errors.” Common examples of hard errors include memory cells that are stuck “high” or “low.” Analogous functionality is present in other forms of memory (e.g., SRAM, Flash, etc.).

In some variants, correctable and uncorrectable faults in the search memory 930 may be categorized differently. More directly, soft errors are correctable faults attributed to probabilistic errors that are expected for the memory technology (such as DRAM leakage); in contrast, hard errors are “uncorrectable faults” that are attributed to hardware failures. The probabilistic accumulation of soft errors during normal operation can be remedied with e.g., a memory rewrite and/or more frequent refresh intervals; in contrast an accumulation of hard errors indicates that the search memory 930 should be replaced.

Artisans of ordinary skill in the related arts given the contents of the present disclosure will readily appreciate that the foregoing example is purely illustrative; various implementations of the foregoing may be modified to adjust a variety of parameters to more or less aggressively mine POW without the risk of suffering undesirable consequences (e.g., higher BER, higher clock rates, and/or lower cost components).

### Third Example Operation, Parallelized Search Memory Architectures

As discussed supra, Ethash validation is highly asymmetric in that a solution is difficult to find, but very easy to verify. Additionally, the nonce selection for Ethash is designed to allow any number of miners to search for solutions in parallel (e.g., each miner randomly selects a nonce). Thus, as shown in FIG. 9C, the present disclosure also envisions architectures that can be used to heavily parallelize search memory architectures.

FIG. 9C is one exemplary embodiment of a parallelized memory architecture according to the present disclosure. As shown in FIG. 9C, the parallelized architecture includes at least one processor 920A which may act as a validation controller apparatus, which is in data communication with both (i) one or more validation memories 910 and (ii) a plurality of search memories 930. The processor 920A that acts as a validation controller apparatus can perform a memory search or hash algorithm utilizing a plurality of search memory devices 930. In some implementations, each of validation controller apparatus 920A and searching processor apparatus 920B can be any one of an application-specific integrated circuit (ASIC) central processing unit (CPU), field-programmable gate array (FPGA), or graphics processing unit (GPU), or yet other types of devices.

With respect to an exemplary operation utilizing the validated memory apparatus of FIG. 9C, each one of the searching processor apparatus 920B can execute a memory search algorithm (e.g., Ethash) to find a POW solution within the memory space of their corresponding searching memory 930. When a header/nonce solution is found, the searching processor apparatus 920B forwards the POW solution to the validation controller apparatus 920A. The validation controller apparatus 920A then validates the POW solution against the validation memory 910. If the header/nonce combination is valid, then the valid solution can be broadcast to the network for validation by the peer nodes of the network. If the solution is invalid then the solution can be ignored or utilized in other ways as discussed in more detail further below.

The highly asymmetric nature of Ethash allows for very high levels of parallelization; a single validation controller apparatus 920A can validate results from an extensive number of searching apparatus 930, 920B (e.g., thousands or tens of thousands of searching apparatus) because empirically validation is ˜1 E10 times faster than generating the POW.

Furthermore, it is noted that this exemplary aspect of the present disclosure (i.e., validation of unreliable search results before the broadcast thereof) is not known from the existing art. Although it is well-known for peer nodes of a network, such as the Ethereum network, to validate solutions broadcast by miners, existing validation mechanisms are focused on the untrusted nature of the actors and assume that faults are malicious. In contrast, the disclosed validation techniques described herein can assume that faults are caused by soft/hard errors of the search memories that may be unreliable (or operated out of normal operating ranges). More directly, the processors 920A and 920B of the exemplary embodiment are not concerned with trust.

Moreover, the existing art is deterred from using search memory (i.e., volatile memory with infrequent or complete absence of refresh) for the reasons explained elsewhere herein (e.g., wasting resources, and possibly a ban from the network); in fact, existing implementations assume that the results from general compute memories are valid and need not be checked before broadcasting the results to the network. In other words, if the miner is not malicious and assumes that their memory has a low (e.g., effectively zero) error rate, then there is no motivation for the submitter to check their own results before broadcasting them.

In one exemplary embodiment, each of the processors and/or memories is capable of isolated operation without other processors in the processing system. In one such variant, each search processor 920B can independently throttle up or down its memory bandwidth to optimize its performance. For instance, based on a determination that its search memory 930 has a higher BER, one search processor 920B can throttle its clock rate up to increase performance and (up to an acceptable BER). In contrast, another search memory 930 that has degraded with use may already have a high BER; therefore, its associated processor 920B would not change its clock rate (or potentially even throttle down). Other independent functionalities may include e.g., maintenance, speed reduction, and/or power consumption reduction.

Artisans of ordinary skill in the related arts given the contents of the present disclosure will readily appreciate that the foregoing example is purely illustrative; various implementations of the foregoing may be modified to adjust a variety of different network topologies. While the illustrated embodiment is presented within the context of a single operating entity, other distributed implementations may be suitable where trust is established in other ways (or altogether unnecessary). For example, a community of users that establish trust collectively can mine Ethash. In other cases, a community of users may not care about its miners being malicious (and submitting many invalid header/nonce solutions).

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. This description is in no way meant to be limiting, but rather should be taken as illustrative of the general principles of the disclosure. The scope of the disclosure should be determined with reference to the claims.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal; however, it will be understood by a person of ordinary skill in the art that the signal may represent a bus of signals, where the bus may have a variety of bit widths.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

What is claimed is:

1. A computing device comprising:
a processing apparatus;
a first memory device in data communication with the processing apparatus, the first memory device having a first level of performance associated therewith;
a second memory device in data communication with the processing apparatus, the second memory device having a second level of performance associated therewith which is lower than the first level; and
a non-transitory computer readable apparatus in data communication with the processing apparatus and comprising a storage medium having a plurality of computer-readable instructions, the plurality of computer-readable instructions, when executed by the processing apparatus, being configured to:
execute an application requiring a plurality of accesses to the second memory device for at least a period of time; and
cause, thereafter, replacement of at least a portion of contents of the second memory device with a respective at least portion of contents of the first memory device.

2. The computing device of claim 1, wherein the application comprises an application with error tolerance at least to the second level of performance.

3. The computing device of claim 1, wherein:
the first and second memory devices comprise volatile memory; and
the computing device is configured to operate at least the second memory device without refresh logic during at least the period of time.

4. The computing device of claim 3, wherein the application comprises an application which utilizes a uniform random access strategy, or a sequentially uniform strategy, for searching the second memory device.

5. The computing device of claim 1, wherein:
the first and second memory devices comprise volatile memory; and
the computing device is configured to operate at least the second memory device at a reduced rate of refresh relative to a design rate of refresh during at least the period of time.

6. A non-transitory computer readable apparatus comprising a storage medium having a plurality of computer-readable instructions, the plurality of computer-readable instructions being configured to, when executed by a processing apparatus:
receive data identifying a prescribed minimum level of performance for use during operation of a volatile memory device;
access a data structure comprising:
first data identifying a plurality of performance values or ranges; and
second data associated with a refresh rate for the respective ones of the plurality of performance values or ranges;
based at least on the received data, select one of the second data; and
cause operation of the volatile memory device with a refresh rate associated with the selected one of the second data.

7. The non-transitory computer readable apparatus of claim 6, wherein the first data and second data of the data structure are based at least in part on a probabilistic characterization of the memory device.

8. The non-transitory computer readable apparatus of claim 6, wherein the plurality of computer-readable instructions are further configured to, when executed by a processing apparatus:
receive data indicative of a parameter associated with the volatile memory device;
evaluate the received data indicative of the parameter; and
cause, based at least on evaluation of the received data:
selection of a different one of the second data from the data structure; and
operation of the volatile memory device with a refresh rate associated with the selected different one of the second data.
